(19) United States
(12) Patent Application Publication
(10) Pub. No.: US 2008/0098008 A1
(43) Pub. Date: Apr. 24, 2008

(54) System and method for teaching entity-relationship modeling

(76) Inventor: Mustafa Eid, Dhahran (SA)

Correspondence Address: LITMAN LAW OFFICES, LTD., P.O. BOX 15035, CRYSTAL CITY STATION, ARLINGTON, VA, 22215, US

(21) Appl. No.: 11/583,030

(22) Filed: Oct. 19, 2006

(51) Int. Cl. G06F 7/00

(52) U.S. Cl. 707/100

(57) ABSTRACT

The system and method for teaching entity-relationship modeling employ graphical organizer templates to systematically analyze the data storage requirements of an organization. The student is taught to apply the templates in logical order, from recognizing the organization's business rules and constraints on those rules, through classification of entities, the relationships between entities, distributive aspects of the relationships, attributes of the entities, identifying required and optional entities, and the cardinality of the relationships. The templates place the information in a graphical or chart form, which may then be easily translated into the formal symbolism of an entity-relationship diagram.

### BACKGROUND OF THE INVENTION

1. Field of the Invention

The present invention relates to database design, and to educational and pedagogical devices for teaching database design to computer programming students and novices, and particularly to a system and method for teaching entity-relationship modeling.

2. Description of the Related Art

Entity-relationship (ER) modeling is considered to be an effective technique used to develop conceptual data models that represent data storage requirements. The ER diagram (ERD) conceptual data modeling technique was proposed in 1976 by Chen. It is agreed by database design researchers that the development of conceptual data models for data storage requirements is an important step for achieving effective database design. However, long personal experience in using and teaching ER modeling has shown that the task of developing correct and complete conceptual ERD models requires experience in ER modeling. The reason is that the ERD modeling technique provides only a set of notations for developing ERD models.

The ER modeling task heavily depends on the modeler's critical thinking and conceptualization abilities. Because there is a lack of useful and clear rules and guidelines in a systematic and procedural format in database design literature, it is noticed that students studying database management courses find the task of ER modeling difficult. Therefore, there is a great need for a systematic method that can improve students' learning of the ER modeling task in shorter time, and to improve the junior modelers' performance of the ER modeling task.

The ER diagram conceptual data model views the real world user data requirements as entities and relationships. It provides a visual representation of data objects and their relationships. The ERD modeling technique involves analyzing the data needs of the organization and, on the way, the users view or conceptualization of the data. Because the data model describes data from the perspective of the organization and not from the perspective of the detailed system processes, it leads to a database that is more adaptable to the data needs of the organization. The ERD technique requires the database designer to conceive of the following: a set of constructs (entity, relationships, attribute, identifier, and dependency) for defining data; rules for controlling how the constructs are drawn to form a data model; and a method for constructing the data model using the construct and rules.

For the database designer, the utility of the ER model is that it maps well to the relational database model. That is, the constructs used in the ER model can easily be transformed into relational tables. The entity-relationship model is simple and easy to understand; therefore, the model can be used by the database designer to communicate the design to the end user. In addition, the model can be used as a design plan by the database developer to implement a data model in specific database management software.

A completed ER diagram model is considered as the blueprint of the database, and the ER diagram is as important to the database designer as a blueprint is to the architect and system builder. Its composition must reflect an organization's business operations/rules accurately if the database is to meet that organization's data requirements. The completed ER diagram model also lets the designer communicate more precisely with those users who commissioned the database design. The completed ER diagram serves as the implementation guide to those who create the actual database.

Thus, a system and method for teaching entity-relationship modeling solving the aforementioned problems are desired.

### SUMMARY OF THE INVENTION

The system and method for teaching entity-relationship modeling employ graphical organizer templates to systematically analyze the data storage requirements of an organization. The student is taught to apply the templates in logical order, from recognizing the organization's business rules and constraints on those rules, through classification of entities, the relationships between entities, distributive aspects of the relationships, attributes of the entities, identifying required and optional entities, and the cardinality of the relationships. The templates place the information in a graphical or chart form, which may then be easily translated into the formal symbolism of an entity-relationship diagram.

These and other features of the present invention will become readily apparent upon further review of the following specification and drawings.

### BRIEF DESCRIPTION OF THE DRAWINGS

FIG. 1 is a flowchart of a method for teaching entity-relationship modeling according to the present invention.

FIG. 2 is a blank template for a Graphical Organizer #1 of a system for teaching entity-relationship modeling according to the present invention.

FIG. 3 is an exemplary filled out template for a Graphical Organizer #1 of a system for teaching entity-relationship modeling according to the present invention.

FIG. 4 is a blank template for a Graphical Organizer #2 of a system for teaching entity-relationship modeling according to the present invention.

FIG. 5 is an exemplary filled out template for a Graphical Organizer #2 of a system for teaching entity-relationship modeling according to the present invention.

FIG. 6 is a blank template for a Graphical Organizer #3 of a system for teaching entity-relationship modeling according to the present invention.

FIG. 7 is an exemplary filled out template for a Graphical Organizer #3 of a system for teaching entity-relationship modeling according to the present invention.

FIG. 8 is a blank template for a Graphical Organizer #4 of a system for teaching entity-relationship modeling according to the present invention.

FIG. 9 is an exemplary filled out template for a Graphical Organizer #4 of a system for teaching entity-relationship modeling according to the present invention.

FIG. 10 is a blank template for a Graphical Organizer #5 of a system for teaching entity-relationship modeling according to the present invention.

FIG. 11 is an exemplary filled out template for a Graphical Organizer #5 of a system for teaching entity-relationship modeling according to the present invention.

FIG. 12 is a blank template for a Graphical Organizer #6 of a system for teaching entity-relationship modeling according to the present invention.

FIG. 13 is an exemplary filled out template for a Graphical Organizer #6 of a system for teaching entity-relationship modeling according to the present invention.

FIG. 14 is a filled out template for a Graphical Organizer #1 of an exemplary company sales processing system illustrating a system and method for teaching entity-relationship modeling according to the present invention.

FIG. 15 is a filled out template for a Graphical Organizer #2 of an exemplary company sales processing system illustrating a system and method for teaching entity-relationship modeling according to the present invention.

FIG. 16 is a filled out template for a Graphical Organizer #4 of an exemplary company sales processing system illustrating a system and method for teaching entity-relationship modeling according to the present invention.

FIG. 17 is a filled out template for a Graphical Organizer #4 of an exemplary company sales processing system illustrating a system and method for teaching entity-relationship modeling according to the present invention.

FIG. 18 is a filled out template for a Graphical Organizer #5 of an exemplary company sales processing system illustrating a system and method for teaching entity-relationship modeling according to the present invention.

FIG. 19 is a filled out template for a Graphical Organizer #6 of an exemplary company sales processing system illustrating a system and method for teaching entity-relationship modeling according to the present invention.

FIG. 20 is a filled out template for a Graphical Organizer #2 of an exemplary company sales processing system illustrating a system and method for teaching entity-relationship modeling according to the present invention.

FIG. 21 is a filled out template for a Graphical Organizer #4 of an exemplary company sales processing system illustrating a system and method for teaching entity-relationship modeling according to the present invention.

FIG. 22 is a filled out template for a Graphical Organizer #4 of an exemplary company sales processing system illustrating a system and method for teaching entity-relationship modeling according to the present invention.

FIG. 23 is a filled out template for a Graphical Organizer #5 of an exemplary company sales processing system illustrating a system and method for teaching entity-relationship modeling according to the present invention.

FIG. 24 is a filled out template for a Graphical Organizer #6 of an exemplary company sales processing system illustrating a system and method for teaching entity-relationship modeling according to the present invention.

FIG. 25 is a filled out template for a Graphical Organizer #2 of an exemplary company sales processing system illustrating a system and method for teaching entity-relationship modeling according to the present invention.

FIG. 26 is a filled out template for a Graphical Organizer #4 of an exemplary company sales processing system illustrating a system and method for teaching entity-relationship modeling according to the present invention.

FIG. 27 is a filled out template for a Graphical Organizer #5 of an exemplary company sales processing system illustrating a system and method for teaching entity-relationship modeling according to the present invention.

FIG. 28 is a filled out template for a Graphical Organizer #6 of an exemplary company sales processing system illustrating a system and method for teaching entity-relationship modeling according to the present invention.

FIG. 29 is a filled out template for a Graphical Organizer #2 of an exemplary company sales processing system illustrating a system and method for teaching entity-relationship modeling according to the present invention.

FIG. 30 is a filled out template for a Graphical Organizer #5 of an exemplary company sales processing system illustrating a system and method for teaching entity-relationship modeling according to the present invention.

FIG. 31 is an exemplary entity-relationship diagram produced from the templates of FIGS. 14-30.

Similar reference characters denote corresponding features consistently throughout the attached drawings.

### DETAILED DESCRIPTION OF THE PREFERRED EMBODIMENTS

The present invention is a system and method for teaching entity-relationship modeling. The system and method employ graphical organizer templates to systematically analyze the data storage requirements of an organization. The student is taught to apply the templates in logical order, from recognizing the organization's business rules and constraints on those rules, through classification of entities, the relationships between entities, distributive aspects of the relationships, attributes of the entities, identifying required and optional entities, and the cardinality of the relationships.

Entity relationship (ER) data modeling is a conceptual modeling technique that is concerned with logically or conceptually representing and describing users' data requirements using well-defined constructs. Constructs means the forms used for representing users' data requirements. The constructs used for representation in the ER model include entities, relationships, and attributes.

To be able to identify candidate entities accurately, it is necessary to understand the following concepts: Entity, Entity Instance, and the kind of entities that can exist in different kinds of user requirements or different problem domains.

An “entity” is something the user is interested to store data about, including a fundamental thing (such as student, course, book, etc), or an action entity (such as student's enrolment), which is based on an event or a business transaction. The other condition that qualifies an entity is that an entity must have characteristics or attributes to become a legitimate entity. An entity in the ERD model terminology is a representation of a set of entity instances with common characteristics. For example, a set of individual students with common characteristics (such as ID, Name, Address, Phone, Date of Birth, etc.) may be represented by the Entity STUDENT. The following rule, which can be used for identifying candidate entities, can be formulated. A candidate entity must at least satisfy the following three conditions: (1) the entity must represent some thing, or an interaction between things, for which the user is interested to store data about; (2) the entity must have characteristics (at least one), and not itself be a characteristic of an entity; and (3) a candidate entity must represent one thing or one concept.

An “Entity Instance” is the individual thing that is represented by an Entity. For example, a particular student named Mohammad Al-Ali is an entity instance of the entity STUDENT.

Entities may be categorized as fundamental entities and derived entities.

A “fundamental entity” is an entity that represents a thing in the user's requirements. Examples are Student or Book in a library system, or a Bank Account in a Banking system. This kind of entity is a fundamental entity. Fundamental entities may be further categorized as “physical” and “conceptual” entities.

A “derived entity” is an entity that is derived from an interaction or relationship between one or more fundamental entities. Example of a derived entity is the associative entity or bridge entity that is usually introduced in the ERD model to resolve M:M (many-to-many) relationship between two entities. For example, student-enrolment entity is introduced into the ERD model of a Student Registration System to resolve the M:M relationship that represents the business rule: a student can enroll in one or more classes, and one class can be used to enroll many students.

An entity that can result from a 1:M (one-to-many) relationship that can exist between a multivalued attribute of an entity and the entity itself is another example of a derived entity. For example, consider the business rule “a faculty possesses more than one qualification,” which the user is interested to store data about in the database. The multi-valued attribute, faculty's qualifications, can be best modeled as an entity related to the Faculty entity as 1:M between the Faculty and Faculty qualification entities.

A “physical entity” is an entity that is concrete and tangible. For example, Student is a physical entity. A “conceptual entity” is an entity that is intangible and not seen, but it exists. For example, Bank Account and Course are conceptual entities. These physical and conceptual entities can be considered as fundamental entities. Some fundamental entities are type entities. Most of the time, type entities are not obvious in the given user's data requirements. For example, a bank account may be Saving, Checking, Credit, or Loan Account. In this business rule, an account type is not mentioned, but it can be deduced because it is not a good idea to keep Account Type details as part of the Bank Account entity details. Each account type may be used by a number of bank accounts, which means one account type can be associated with many bank accounts.

Usually, this kind of relationship between the type entity and the related entity is one to many (1:M). Because storing data facts (details) of type entities is important and needed by users in many applications, it is necessary to propose type entities in ERD models, even if they are not clearly written in business rules of the problem domain. One important modeling activity is the conceptualization of entities, which is concerned with the identification and validation of entities, relationships, and attributes.

To support and guide the thinking/cognitive processes of the modeler/learner during the ER modeling task, the present invention uses a set of formulated graphical organizers. A graphical organizer (described below) will be used to define entities, relationships, and attributes respectively. In general, a good understanding of a user's requirements represented by the business rules of a problem domain is a key factor in achieving correct and complete identification of entities, relationships, and attributes.

“Relationships” are associations between data entities. For example, a student enrolls in a number of classes (course sections). This statement indicates there is a relationship between the student entity and class entity. Relationships result from business rules (which describe business operations/transactions) or natural relationships between entities.

In ER diagram modeling technique, three types of relationships are used to represent associations between data entities. These are: a one-to-one relationship, represented as 1:1; a one-to-many relationship, represented as 1:M; and a many-to-many relationship, represented as M:M. For example, the relationship “An instructor can only coordinate one course” is a 1:1 relationship; the relationship “An instructor teaches one or more courses” is a 1:M relationship; and the relationship “A student may enroll in one or more classes and one class may be used to enroll one or more students” is a M:M relationship.

Usually, M:M relationships result in a new entity called an associative entity (bridge entity). In general, the associative entity represents data characteristics of a business operation involving two entities. For example, the students' enrollment details that result from the enrollment business action/operation need to be represented by a new associative entity.

Relationships can be classified into three categories: M:M (many-to-many); 1:M (one-to-many); and 1:1 (one-to-one).

M:M relationships may be further categorized into action-based relationships and recursive relationships. An “action-based relationship” represents an interaction between two or more entities. Usually, action-based relationships are represented by a many-to-many relationship in the ER diagram model, thereby resulting in an Associative or Bridge Entity. Because implementing many-to-many relationships results in data redundancy, a bridge entity is introduced to resolve a many-to-many (M:M) relationship into two one-to-many (1:M) relationships.

A “recursive relationship” results when each entity instance can be related to a set of entity instances of the same entity. For example, a course has zero or many prerequisite courses, and one course can be used as a prerequisite for zero to many courses. If the relationship between instances of the same entity is M:M, then a new bridge entity will result from the M:M recursive relationship.

1:M relationships can be further categorized as dependency relationships, master-details relationships, whole-part relationships, and recursive relationships. An entity may result from a “dependency relationship” between two entities. For example, an employee has children, and the user wants to keep data about the employee and their children. In other cases, a dependency relationship may result when an entity may be identified to resolve a multivalued attribute that can exist in a fundamental entity. For example, the employee entity has an attribute called qualification. But some employees have multiple qualifications. This means the qualification attribute will have multiple values, which cannot be handled in one attribute. This situation represents a dependency relationship between the employee entity and employee's qualifications, and therefore it is best modeled as 1:M relationship existing between the employee entity and the employee's qualifications entity.

An entity may result from a “master-detail relationship” between two entities. For example, an order has order items and an invoice has invoice lines.

An entity may result from a “whole-part relationship” between two entities. For example, a building has rooms, and a room has furniture items.

A one-to-many “recursive relationship” results when one entity instance is related to another instance of the same entity. For example, an employee manages zero or many employees. If the recursive relationship between instances of the same entity is 1:M, then a new entity may result from the recursive relationship.

1:1 relationships may be further categorized into a general-special relationship, a recursive relationship, a dependency relationship, and a whole-part relationship. An entity may result from a “general-special relationship” between two entities. For example, an employee is a person.

A 1:1 “recursive relationship” may result, for example, when one employee manages one department in an organization. In this case, no new entity will result from this kind of recursive relationship. A 1:1 “dependency relationship” is exemplified, e.g., by the business rule that a book has one publisher. A 1:1 “whole-part relationship” is exemplified, e.g., by the business rule that one car has one engine.

Database design, when based on the ERD modeling process, consists of a set of modeling activities that are mainly concerned with the identification, refining, and integration of entities, attributes, and relationships in a complete ERD model that satisfies a user's database needs. ER modeling is an iterative rather than a linear or sequential process. The iterative process is based on the repetition of certain modeling activities to produce a complete ERD model

User data requirements are usually gathered from interviewing an organization's users, reviewing and observing business operations, procedures, forms, reports, and other documentation related to the organization's functions. After collecting the user's requirements, the data need to be organized into business rules to form a problem domain. Business rules describe business activities (that is, business operations or business transactions). Also, some business rules have restrictions and exceptions.

Basically, the ERD modeling process starts with the organization and interpretation (understanding) of business rules existing in the given problem domain. Then the modeler starts the identification of entities; linking the entities using relationships; and lastly, the modeler identifies attributes of entities, including keys. However, these activities run in a few cycles until a satisfactory ERD model is reached. Therefore, the process is an iterative process consisting of two major phases, namely, the Organization of Business Rules and Modeling Activities.

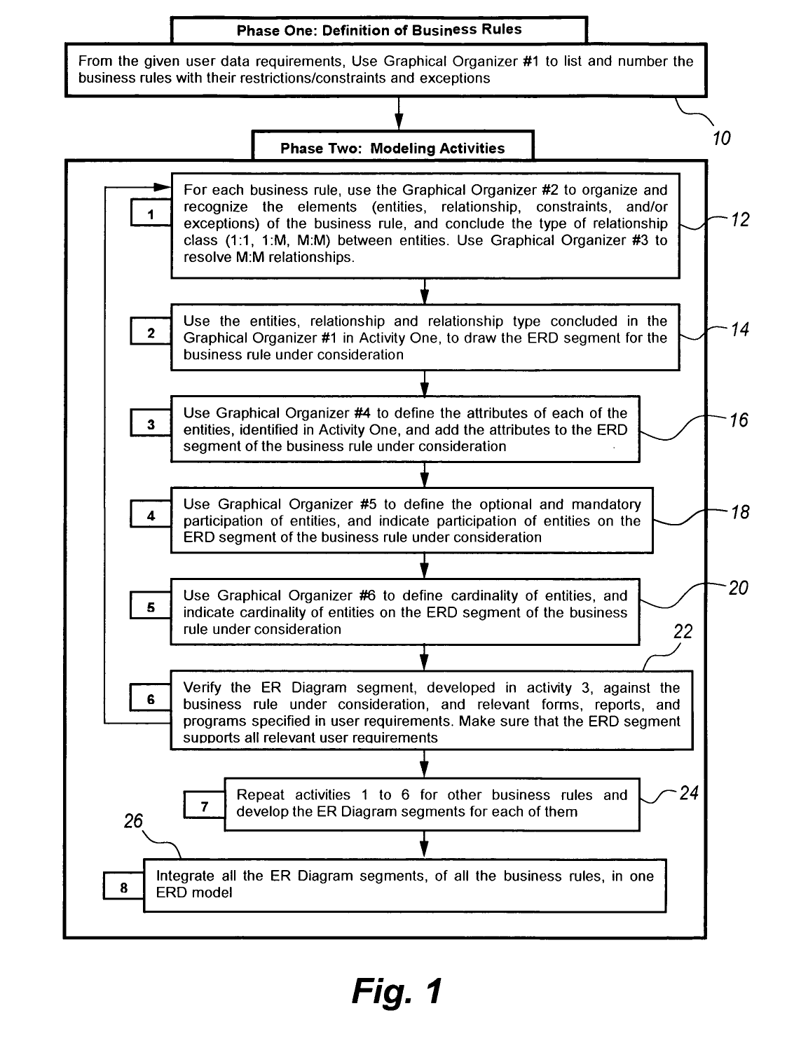

Each of the two phases has a number of steps. The proposed process according to the present invention is depicted graphically in FIG. 1. In order to support the critical thinking involved in the above two phases of the ER modeling task, a series of six graphical organizers are formulated and used in the process, as indicated.

In the first phase, Graphical Organizer #1 is used to list the business rules with their restrictions or constraints, as well as exceptions to the rules, as indicated at step 10.

The second phase involves several steps. For each business rule identified on Graphical Organizer #1, a Graphical Organizer #2 is prepared to organize and recognize the elements of the business rule and the category of relationship between entities, using Graphical Organizer #3 to resolve M:M relationships, all as indicated at step 12. From the foregoing analysis, an ERD segment is drawn for each business rule, as indicated at step 14. Then Graphical Organizer #4 is used to identify the attributes of each entity, and the attributes are added to the corresponding ERD segment, as indicated at step 16.

Graphical Organizer #5 is used to define the optional and mandatory participation of the entities in the various relationships, and the appropriate ERD segment is modified accordingly, as indicated at step 18. Next, Graphical Organizer #6 is used to define the cardinality of the entities, and the appropriate ERD segment is notated accordingly, as indicated at step 20. The ERD segment for the selected business rule is verified against the relevant organization's documentation and requirements, as indicated at step 22, repeating steps 12-20 as required.

Steps 12 through 22 are repeated for each business rule, as indicated at step 24. Finally, each of the ERD model segments are integrated into a single ERD model, as indicated at step 26.

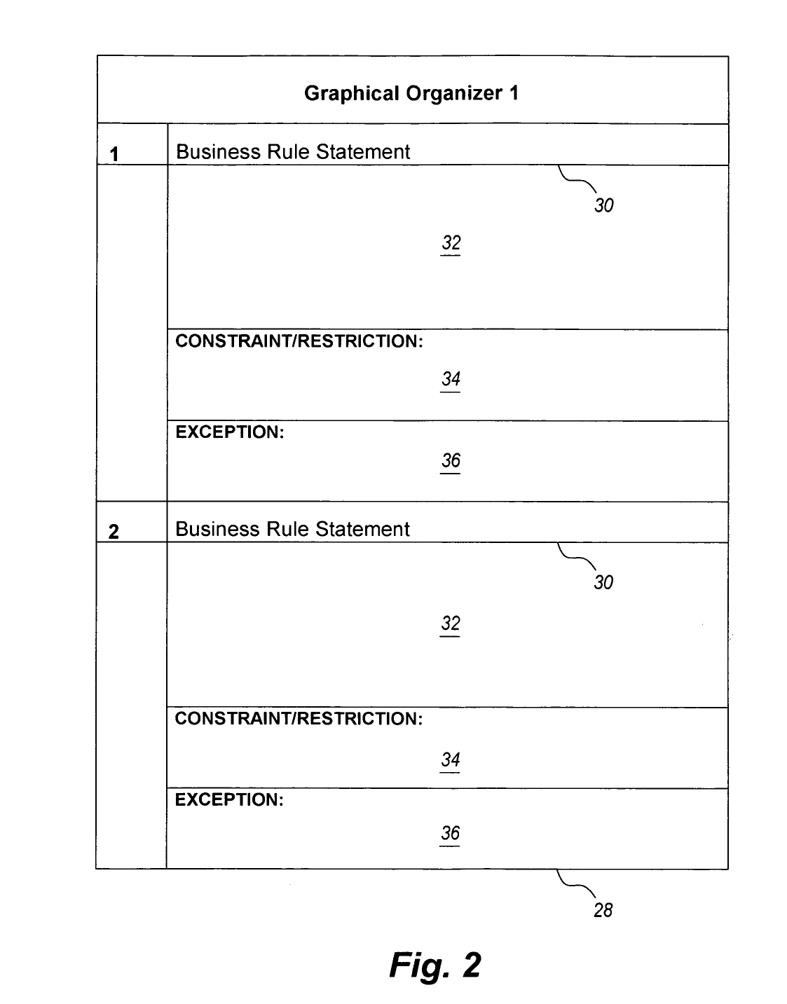

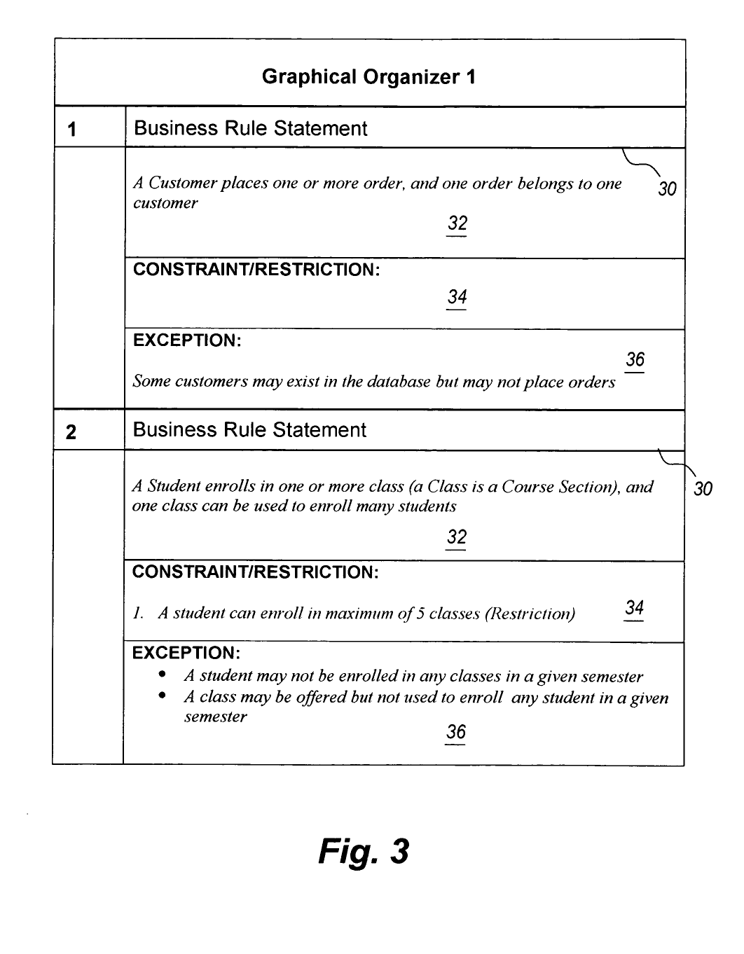

A blank Graphical Organizer #1, designated generally as 28 in the drawings, is shown in FIG. 2, and an exemplary completed template 28 is shown in FIG. 3. Graphical Organizer #1 is used to organize the information related to each one of the business rules that exist in the given user's requirements into a format that is easy to interpret and that focuses on recognizing the elements of business rule: entities, relationships and constraints and/or exceptions. A business rule briefly describes a business process/operation that exists in a user's requirements.

The template 28 is broadly divided into separate sections for each business rule by numbered boxes 30 that extend across the width of the template 28. Each numbered box 30 is followed by a sequence of boxes of smaller width, including a box 32 for statement of the business rule, a labeled box 34 for statement of constraints and restrictions on the business rule, and a labeled box 36 for statement of exceptions to the business rule. FIG. 3 shows a sample filled-out template 28, the two business rule statements applying to different users or organizations to illustrate how Graphical Organizer #1 can be adapted to different organizations.

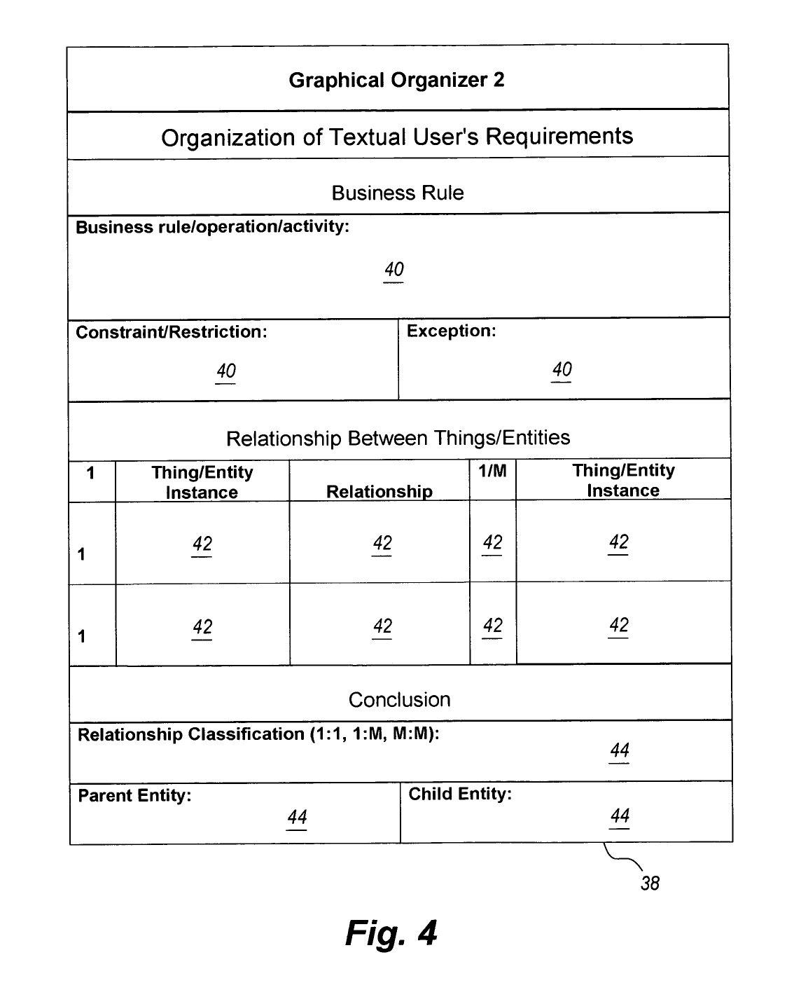

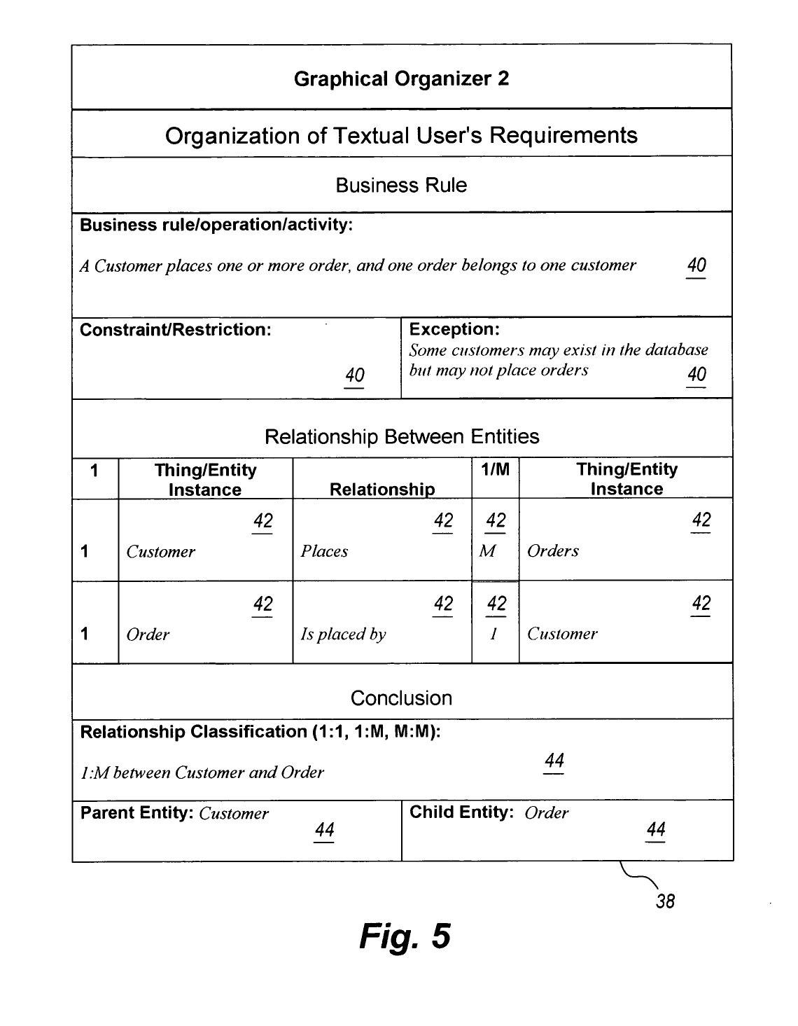

FIG. 4 shows a blank Graphical Organizer #2, designated generally as 38 in the drawings, and an exemplary completed template 38 is shown in FIG. 5. Graphical Organizer 2 is used to organize the information related to each one of the business rules developed in Graphical Organizer #1 into a format that is easy to interpret and recognize the elements of business rule. The elements of a business rule include the actor and/or things, the action, event and/or relationship between actors or things. Based on the understanding and recognition of the business rule's elements, the modeler will try to define candidate entities and relationships and then make conclusion on the kind of relationship connectivity (1:1, 1:M, or M:M).

Therefore, Graphical Organizer 2 helps the cognitive processes involved in formatting a business rule, recognizing its elements, and concluding the ERD segment for the business rule. This organization and refinement of textual user requirements is assumed to help guide the modeler through the process of ER modeling. For example the Graphical Organizer 2 shown in FIG. 4 can be considered as a template used to refine the problem domain business rules/operations/activities. This graphical organizer or template helps lead the modeler to determine the business rule key elements, which are useful for the identification of candidate entities and relationships.

The template 38 has a top section including boxes 40 for restating the particular business rule being examined, its constraints/restrictions and exceptions. Below the top section is a middle section of labeled boxes 42 arranged in rows to show the relationship between pairs of entities and their distributive aspect (1:1, 1:M, or M:M). Below the middle section is a bottom section of labeled boxes 44 for stating conclusions regarding the distributive classification of the relationship, and for identifying any parent and child entities. FIG. 5 shows an exemplary Graphical Organizer #2, filled out for a sales processing system.

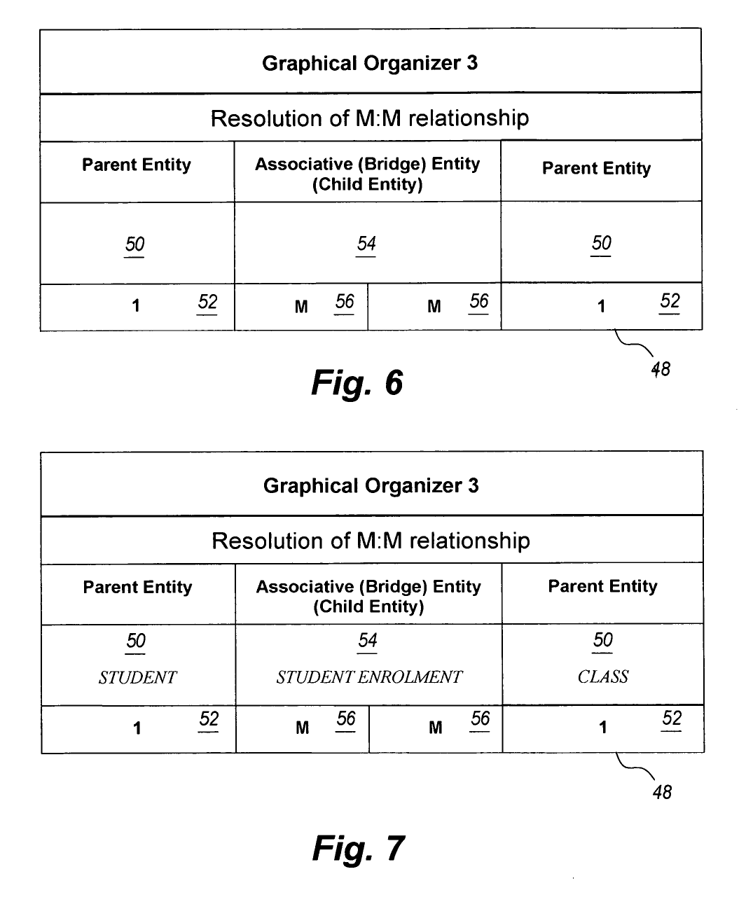

A blank Graphical Organizer #3, designated generally as 48 in the drawings, is shown in FIG. 6, and an exemplary completed template 48 is shown in FIG. 7. Graphical Organizer #3 is used to clarify the distributive aspects of a M:M (many-to-many) relationship, and to identify any associative, bridge, or child entities that have corresponding intermediate 1:M and M:1 relationships. Since the M:M relationship does not translate well into a database, it is common in the design phase to create a bridge entity to split the M:M relationship into two 1:M relationships. The template 48 contains a row of labeled outside blocks 50 for the parent entities situated above blocks 52 identifying the parent entities as the “1” component of the relationship, and a central box 54 for identifying the bridge entity situated above a split column block 56 identifying the bridge entity as the “M” component of the 1:M and M:1 relationships.

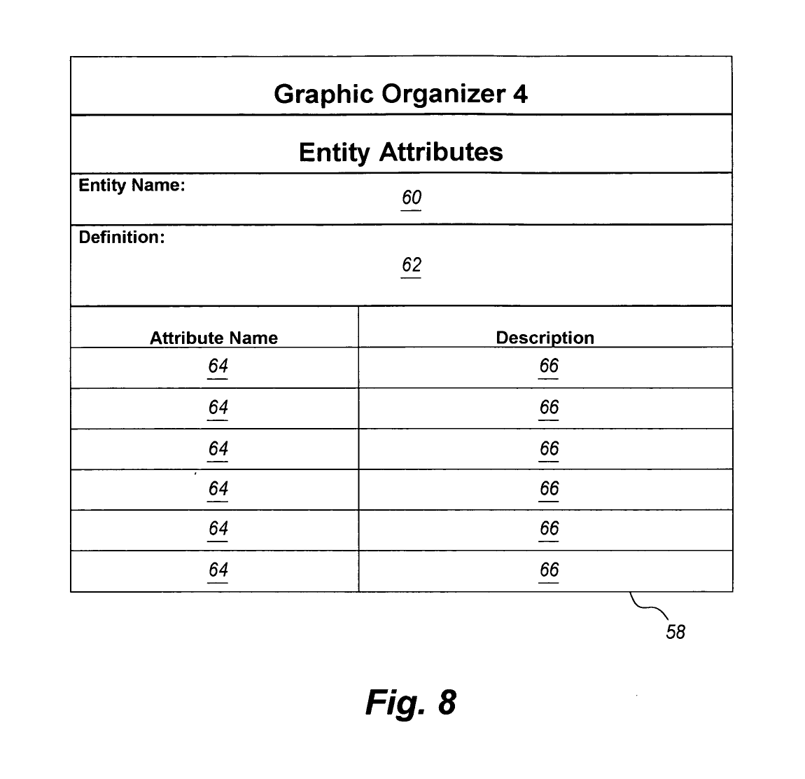

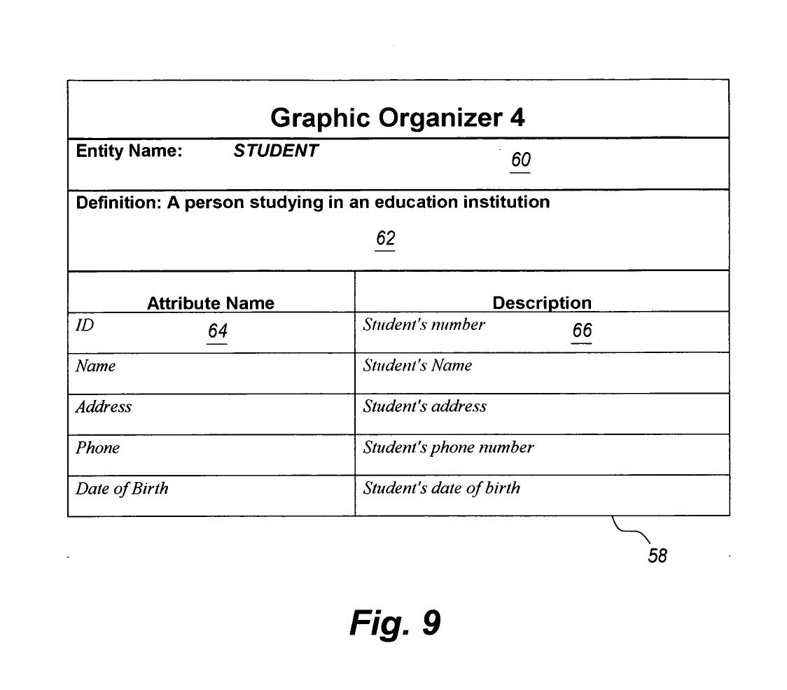

A blank Graphical Organizer #4, designated generally as 58 in the drawings, is shown in FIG. 8, and an exemplary completed template 58 is shown in FIG. 9. Graphical Organizer #4 is used to define the attributes of an entity based on the characteristics of the entity. For example, the characteristics of a student entity are ID, Name, Address, Phone, Date of Birth, etc. The template 58 includes a rectangular identification block 60 for identifying the entity by name, a definition block 62 immediately below the identification block 60, and a split column of blocks 64 and 66 immediately below the definition block 62 for listing each attribute and a description of the attribute respectively, corresponding to the entity named in identification block 60. Attributes may be notated on an ERD adjacent the entity.

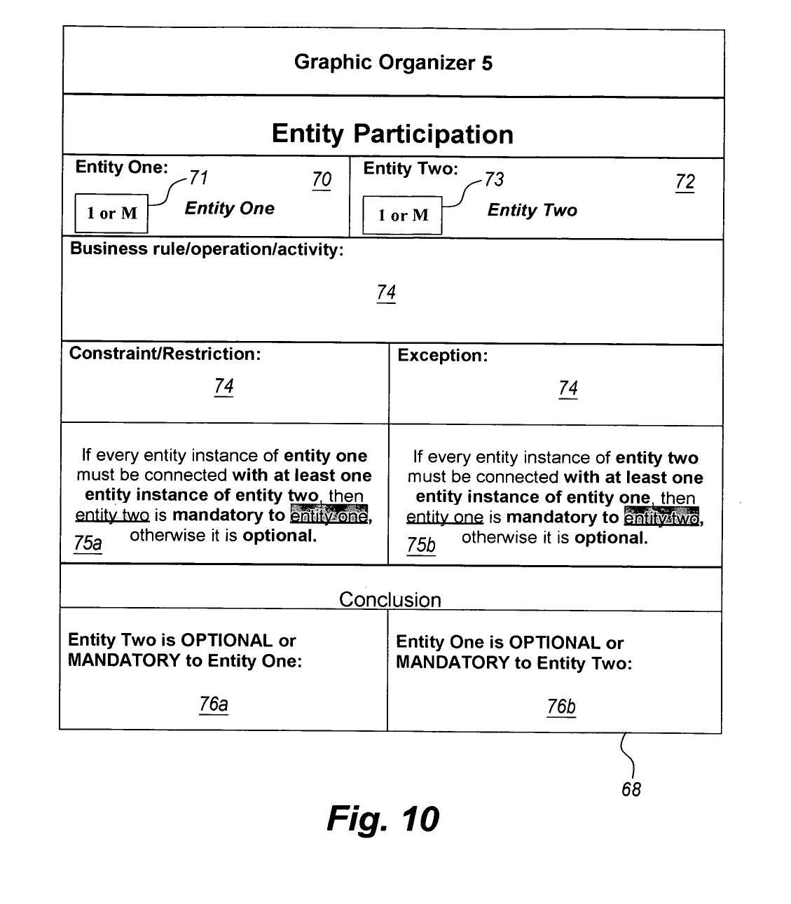

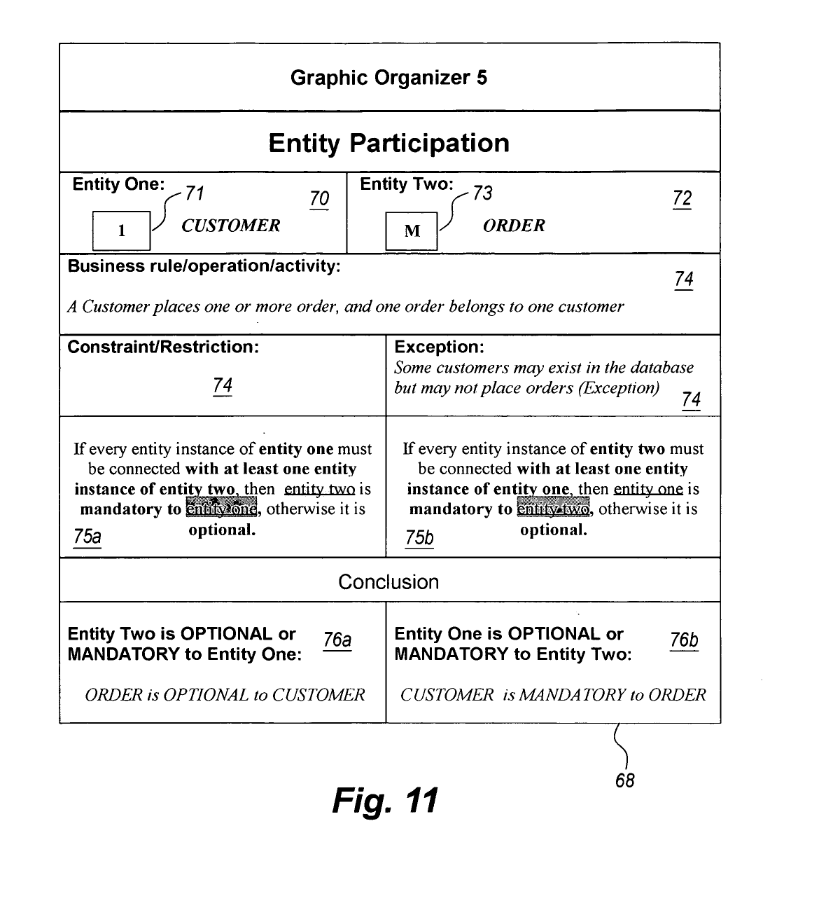

A blank Graphical Organizer #5, designated generally as 68 in the drawings, is shown in FIG. 10, and an exemplary completed template 68 is shown in FIG. 11. Graphical Organizer #5 is used to define the entity participation in a relationship between two entities. Graphical Organizer #5 includes a split column of entity name blocks 70 and 72 for naming the two entities being considered in the template 68, each entity name block having a corresponding distribution block 71 and 73 embedded therein to indicate the distributive character of the named entity in the entity relationship, as determined in Graphical Organizer #2, i.e., distribution blocks 71 and 73 will contain an entry of “1” or “M” according to whether the entity corresponds to a one or many in a 1:1, 1:M or M:M relationship.

Immediately below the entity name blocks 70 and 72, the template 68 includes blocks 74 for stating the business rule, its constraints/restrictions, and exceptions, which are also carried over from Graphical Organizer #2. Below the business rule blocks 74 is a split column of blocks 75a and 75b, which contain statements of the rule for determining whether the named entity's participation in the relationship is mandatory or optional. Finally, the template 68 includes a split column of conclusion blocks 76a and 76b to summarize the corresponding conclusion for the two entities named in entity name blocks 70 and 72. The mandatory or optional nature of the entity's participation in the relationship may be symbolically notated on the ERD by a circle drawn through the connecting line between the entities to reflect that the relationship is optional.

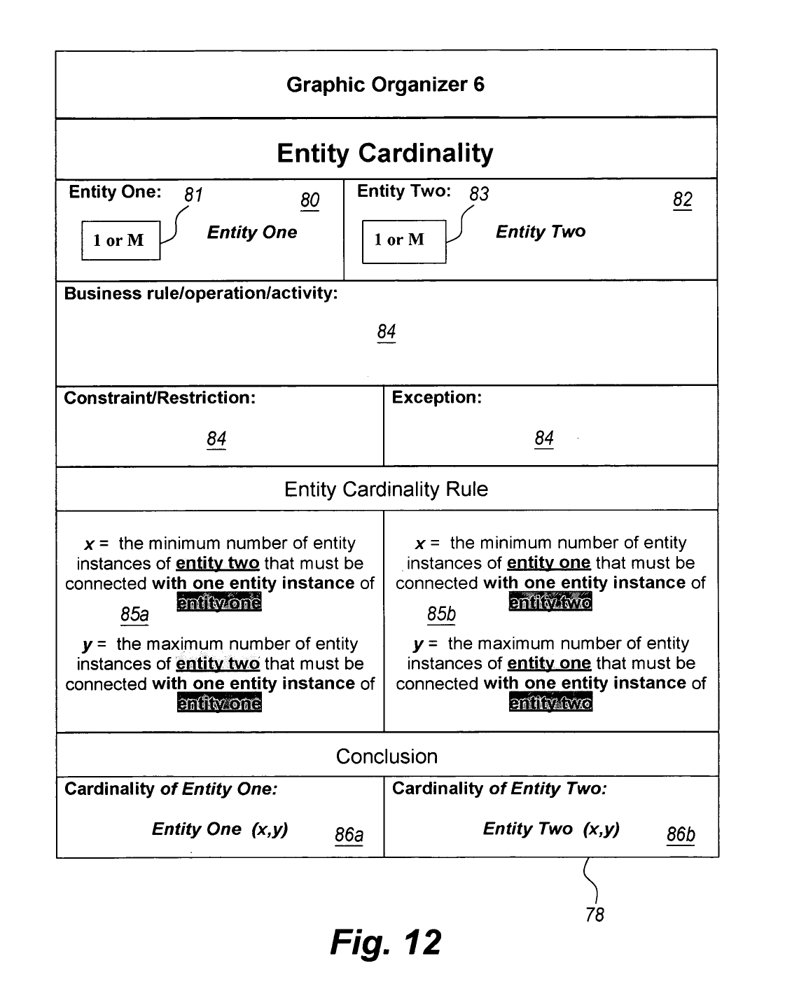

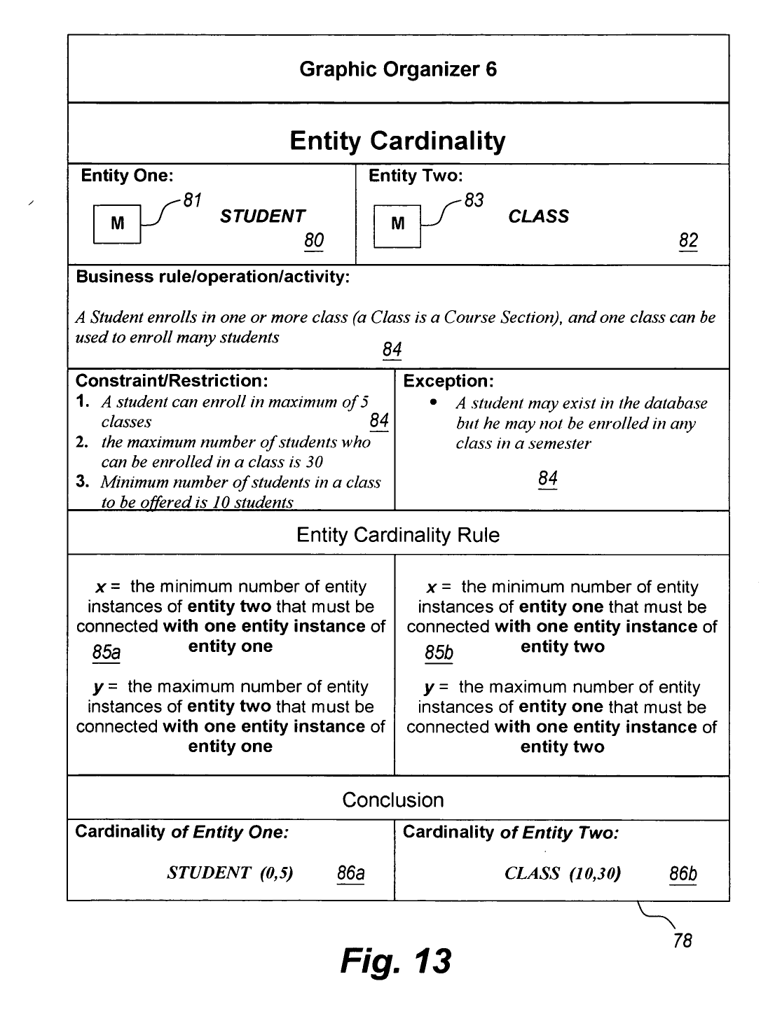

A blank Graphical Organizer #6, designated generally as 78 in the drawings, is shown in FIG. 12, and an exemplary completed template 78 is shown in FIG. 13. Graphical Organizer 6 is used to define the entity cardinality in a relationship between two entities. Graphical Organizer #6 includes a split column of entity name blocks 80 and 82 for naming the two entities being considered in the template 78, each entity name block having a corresponding distribution block 81 and 83 embedded therein to indicate the distributive character of the named entity in the entity relationship, as determined in Graphical Organizer #2, i.e., distribution blocks 81 and 83 will contain an entry of “1” or “M” according to whether the entity corresponds to a one or many in a 1:1, 1:M or M:M relationship.

Immediately below the entity name blocks 80 and 82, the template 78 includes blocks 84 for stating the business rule, its constraints/restrictions, and exceptions, which are also carried over from Graphical Organizer #2. Below the business rule blocks 84 is a split column of blocks 85a and 85b, which contain statements of the rule for determining the cardinality of the named entity in the relationship, i.e., the minimum and maximum numbers of the related entity connected with the named entity. Finally, the template 78 includes a split column of conclusion blocks 86a and 86b to summarize the corresponding conclusion for the two entities named in entity name blocks 80 and 82. The cardinality of each entity may be symbolically notated on the ERD.

### EXAMPLE

The application of the templates can be illustrated by application to a sales company database application. For purposes of the example, a marketing company wishes to create an information system to process and manage their sales business operations. Products sold by the company are supplied by vendors. The company resells the products to business customers on credit basis. Each customer must have a record in the sales company's database.

The customers can have credit limits for their accounts. When a customer purchases products, they receive invoices for their purchases and by the 20^{th} day of the month they receive statements for their monthly purchases, which should be paid within seven days after the statement date.

The invoice that a customer receives includes a number of line products. Each line in the invoice shows a line number, product description, number of units, charged price per unit, and total value per line, etc. Each line in an invoice refers to a certain product, which exists in the database.

The application of the proposed method is based on the proposed process shown in FIG. 1, which consists of two phases. Phases one and two are implemented and the resulting ERD model follows.

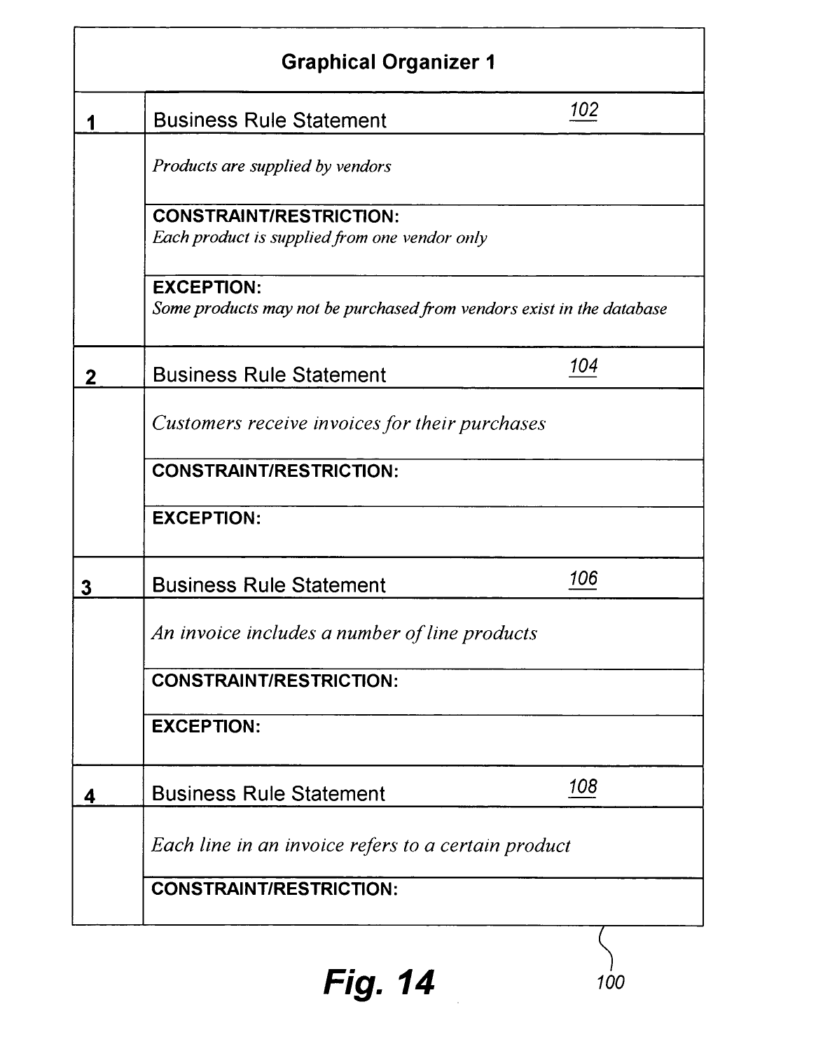

FIG. 14 shows the implementation of phase one by execution of the Graphical Organizer #1 template 100 to identify and summarize the business rules and their corresponding constraints/restrictions and exceptions. Four business rules are identified in template 100, designated as the first 102, second 104, third 106, and fourth 108 business rules, respectively.

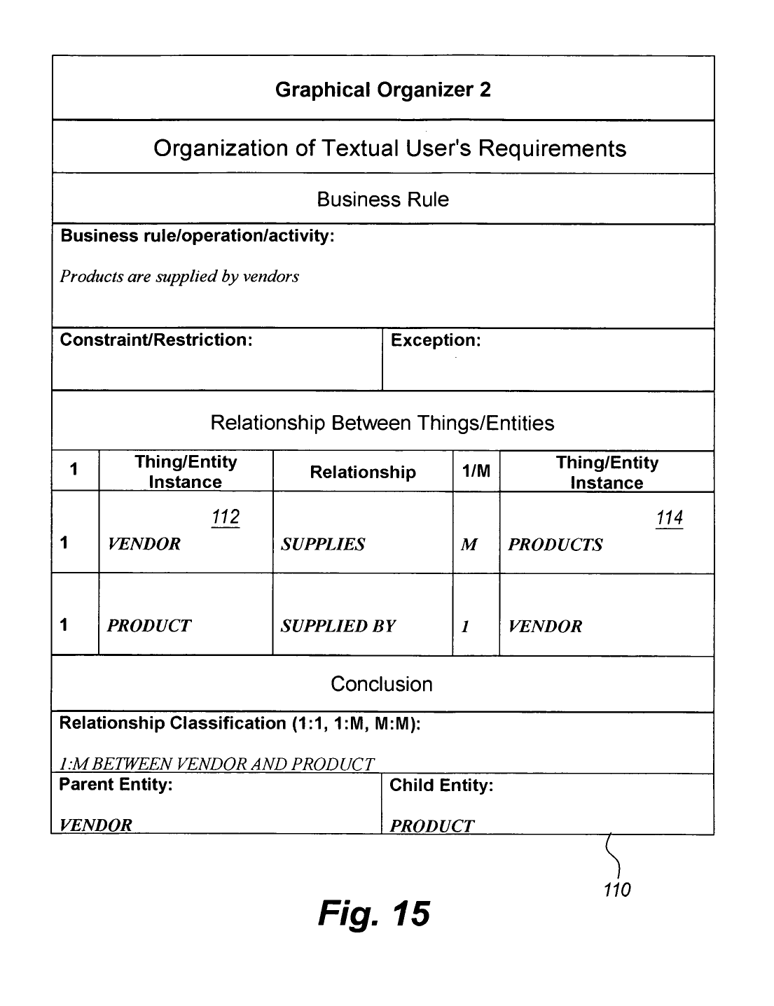

Phase two may then be implemented by the execution of the various templates shown in FIGS. 15-30. FIG. 15 shows a Graphical Organizer #2, designated as template 110, directed towards the first business rule 102. Template 110 identifies a Vendor entity at block 112 and a Product entity at block 114.

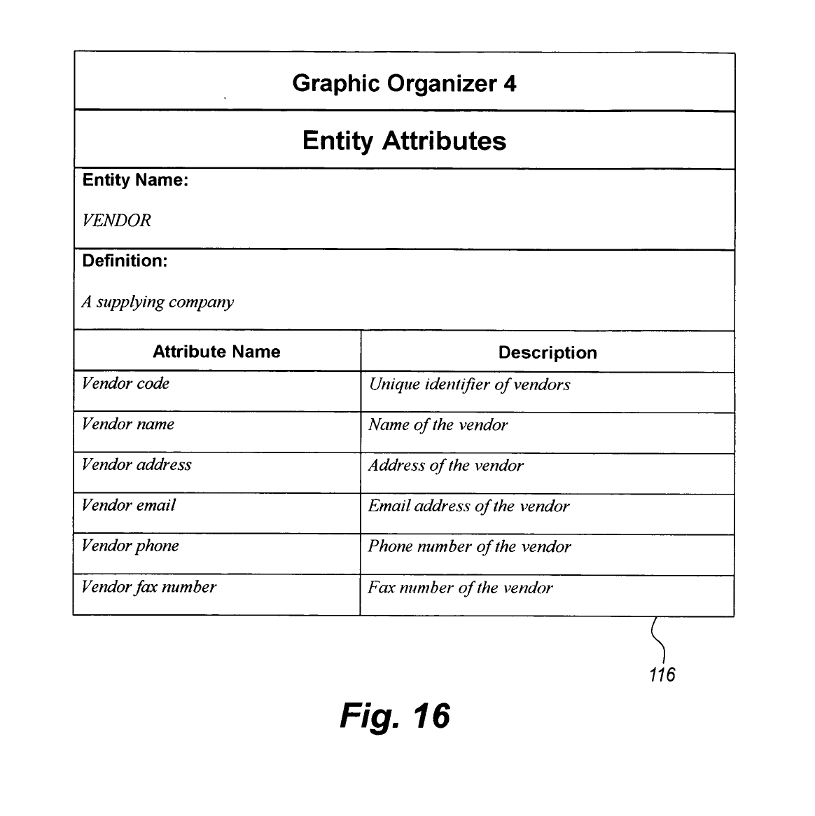

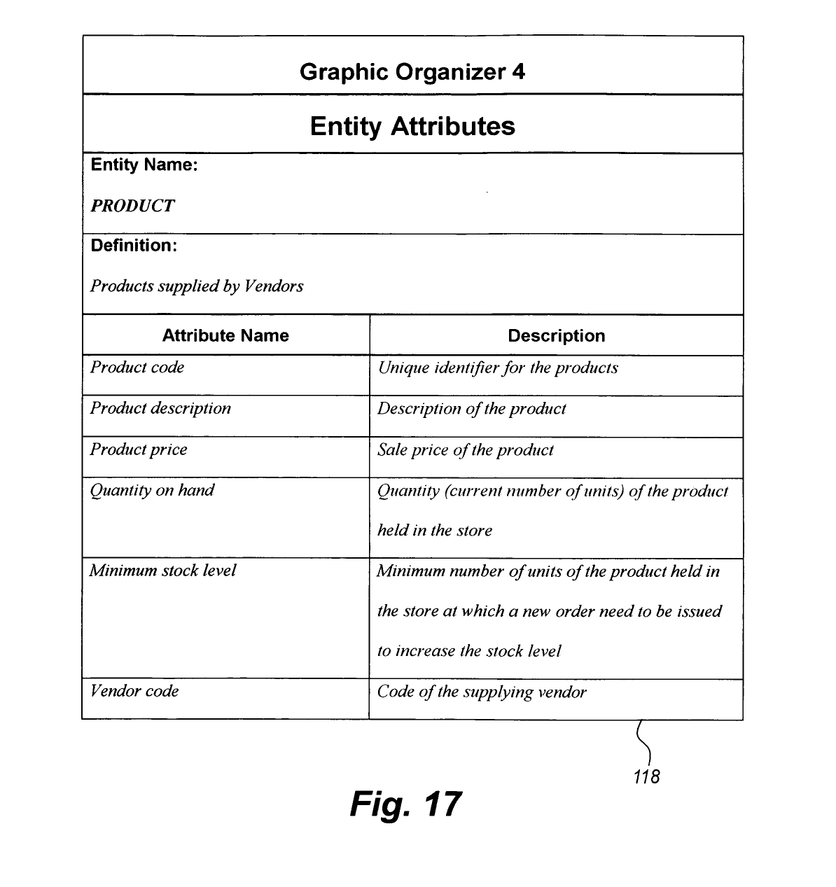

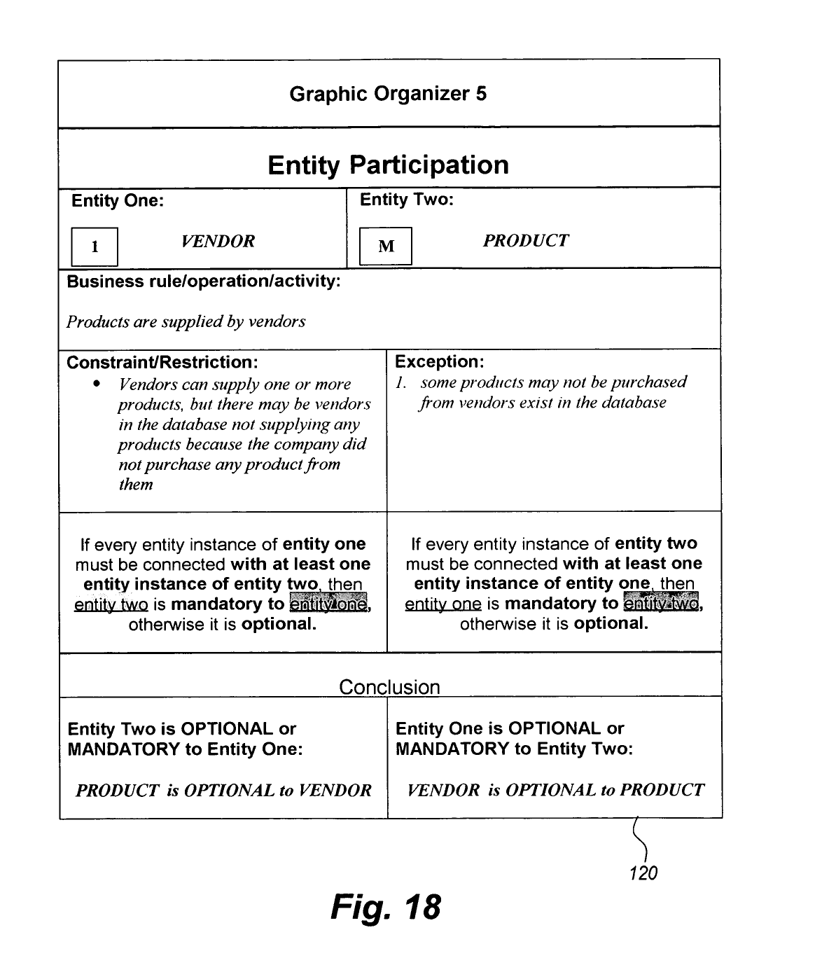

FIG. 16 shows a Graphical Organizer #4 template, designated as template 116, completed to show the attributes of the Vendor entity identified by template 110. FIG. 17 shows a Graphical Organizer #4 template, designated as template 118, completed to show the attributes of the Product entity identified by template 110. FIG. 18 shows a Graphical Organizer #5, designated as template 120, completed for the Vendor-Product relationship identified as 1:M by template 110, and concludes that the Product entity is optional to the Vendor entity, and that the Vendor entity is also optional to the Product entity.

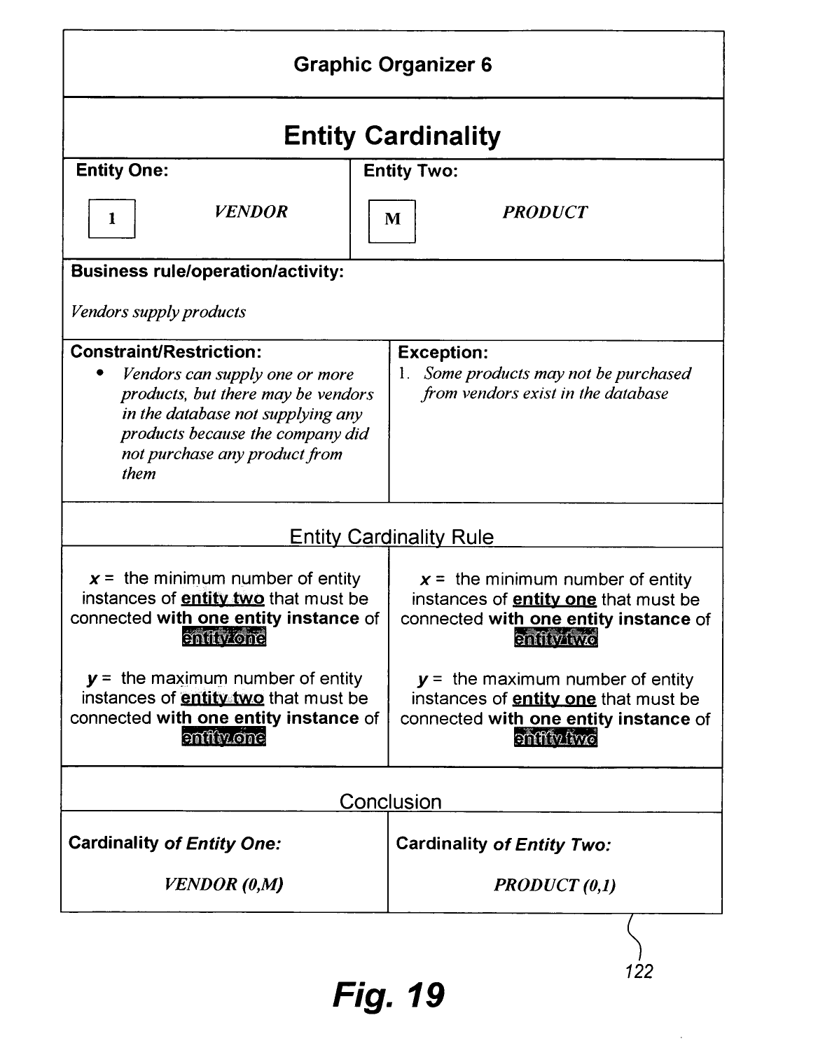

FIG. 19 shows a Graphical Organizer #6 template, designated as template 122, showing the cardinality of the Vendor and Product entities in the Vendor-Product relationship, viz., (0,M) for the Vendor entity and (0,1) for the Product entity.

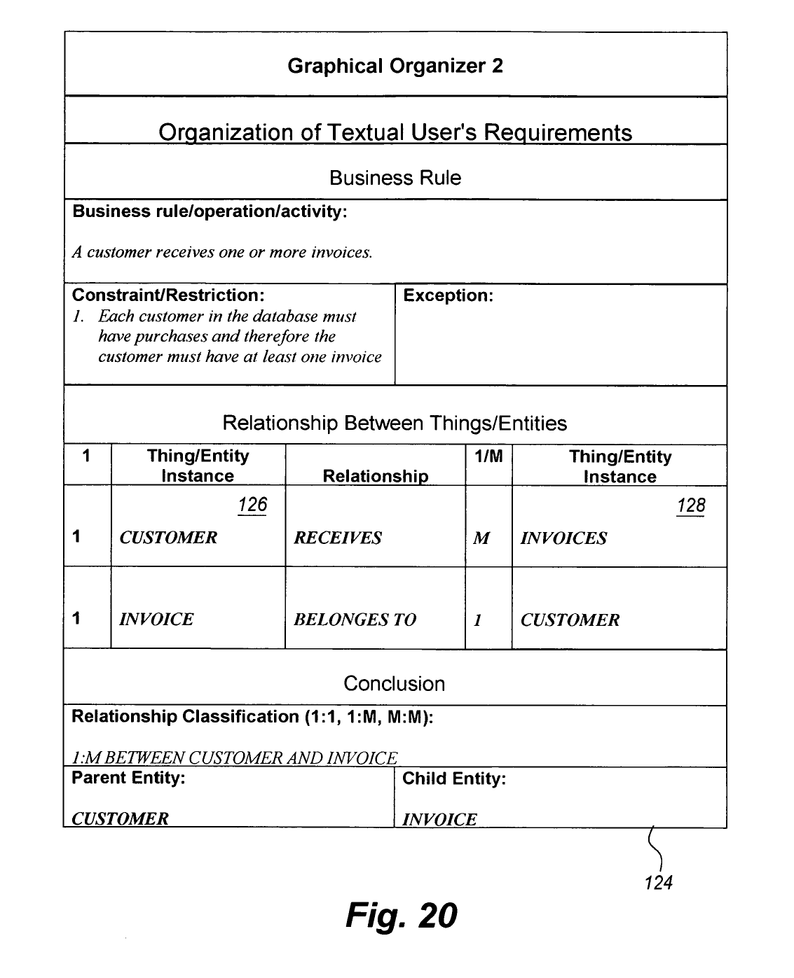

FIG. 20 shows a Graphical Organizer #2 template, designated as template 124, completed for the second business rule 104 identified by template 100. Template 124 names the entities identified by the second business rule 104 as the Customer entity in block 126 and the Invoice Entity in block 128.

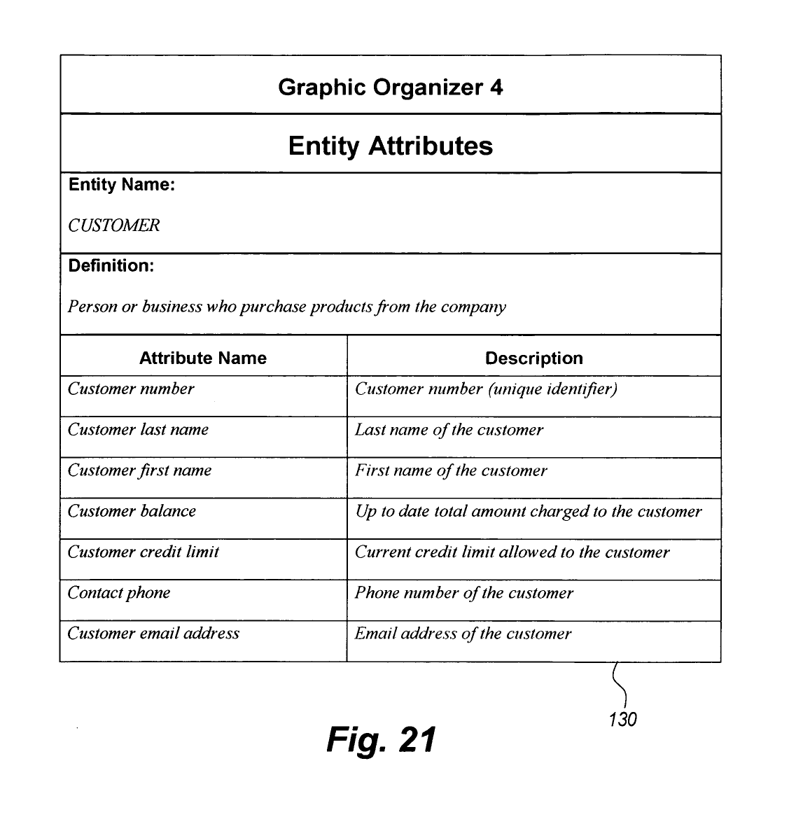

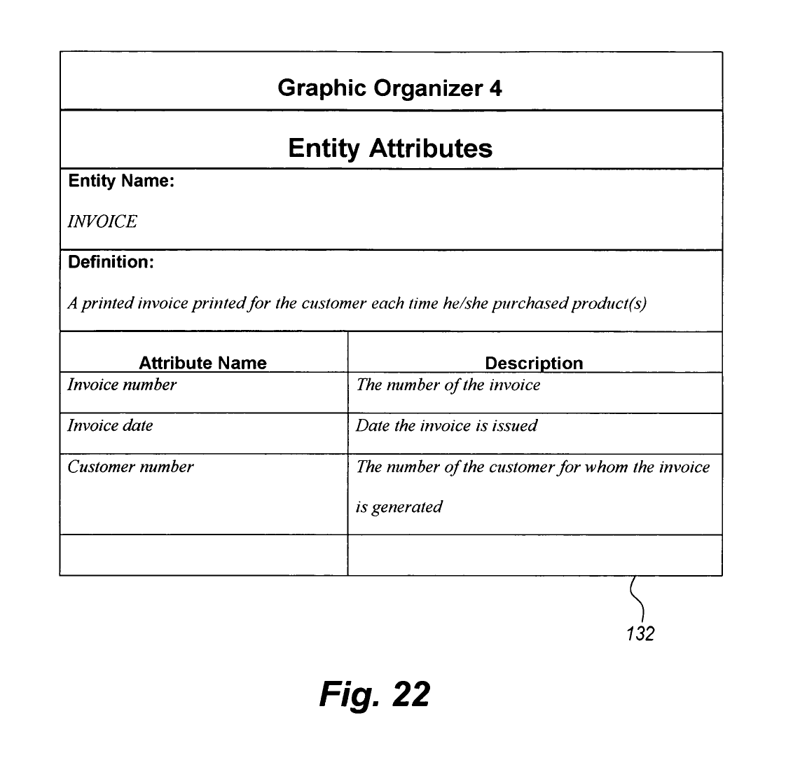

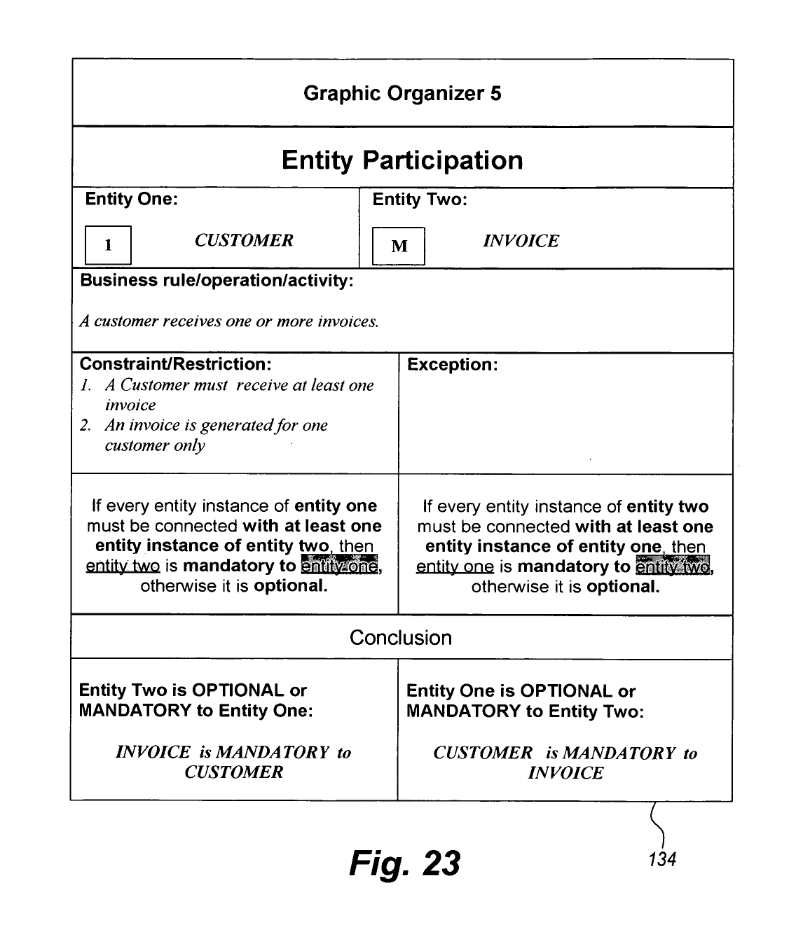

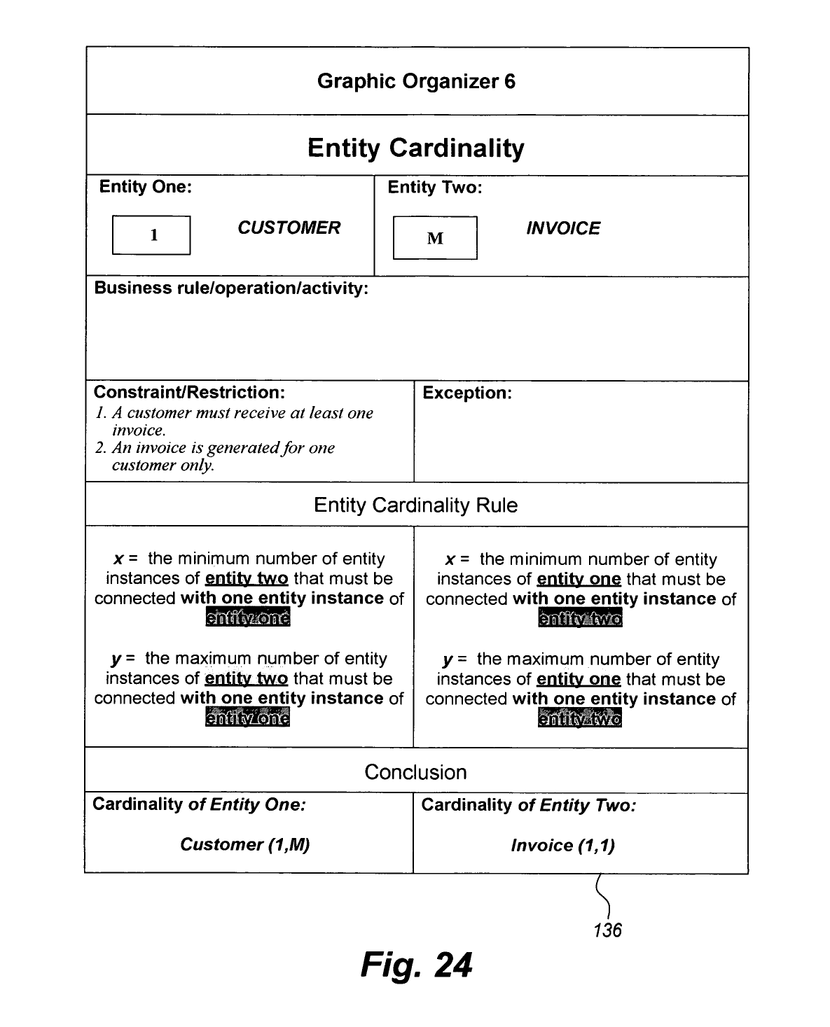

FIG. 21 shows a Graphical Organizer #4 template, designated as template 130, summarizing the attributes of the Customer entity identified by template 124. FIG. 22 shows a Graphical Organizer #4 template, designated as template 132, summarizing the attributes of the Invoice entity identified by template 124. FIG. 23 shows a Graphical Organizer #5 template, designated as template 134, completed for the Customer-Invoice relationship identified as 1:M by template 124, and concludes that the Invoice entity is mandatory to the Customer entity, and that the Customer entity is also mandatory to the Invoice entity. FIG. 24 shows a Graphical Organizer #6 template, designated as template 136, showing the cardinality of the Customer and Invoice entities in the Customer-Invoice relationship, viz., (1,M) for the Customer entity and (1,1) for the Invoice entity.

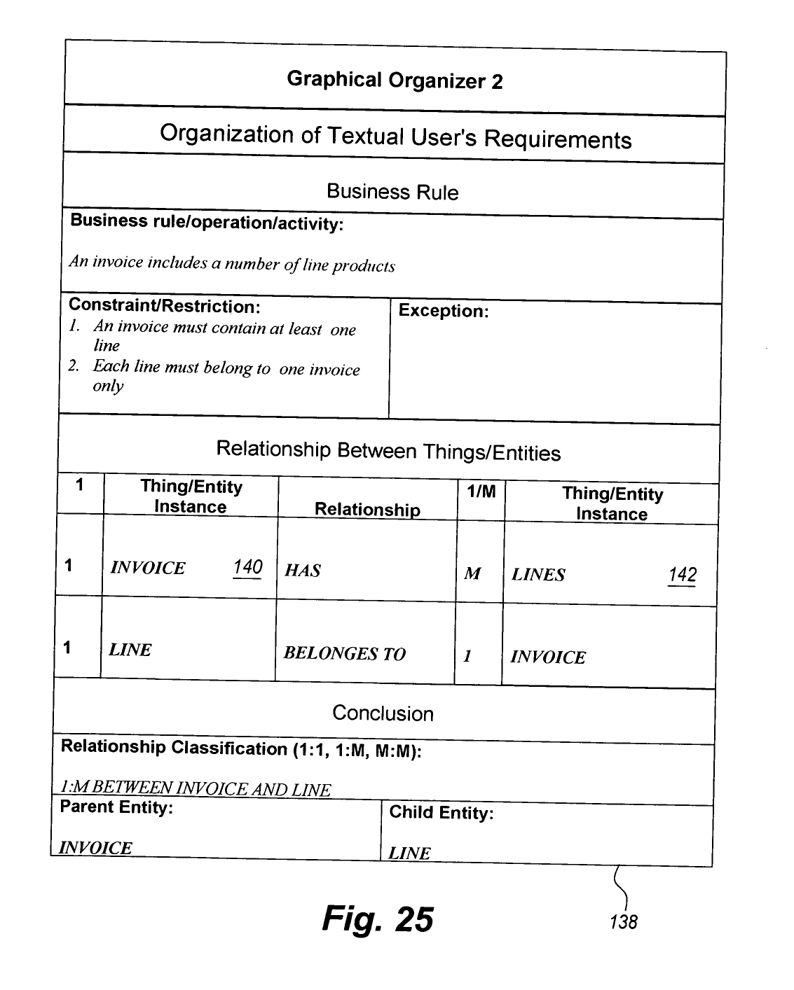

FIG. 25 shows a Graphical Organizer #2 template, designated as template 138, completed for the third business rule 106 identified by template 100. Template 138 names the entities identified by the third business rule 106 as the Invoice entity in block 140 and the Line Entity in block 142.

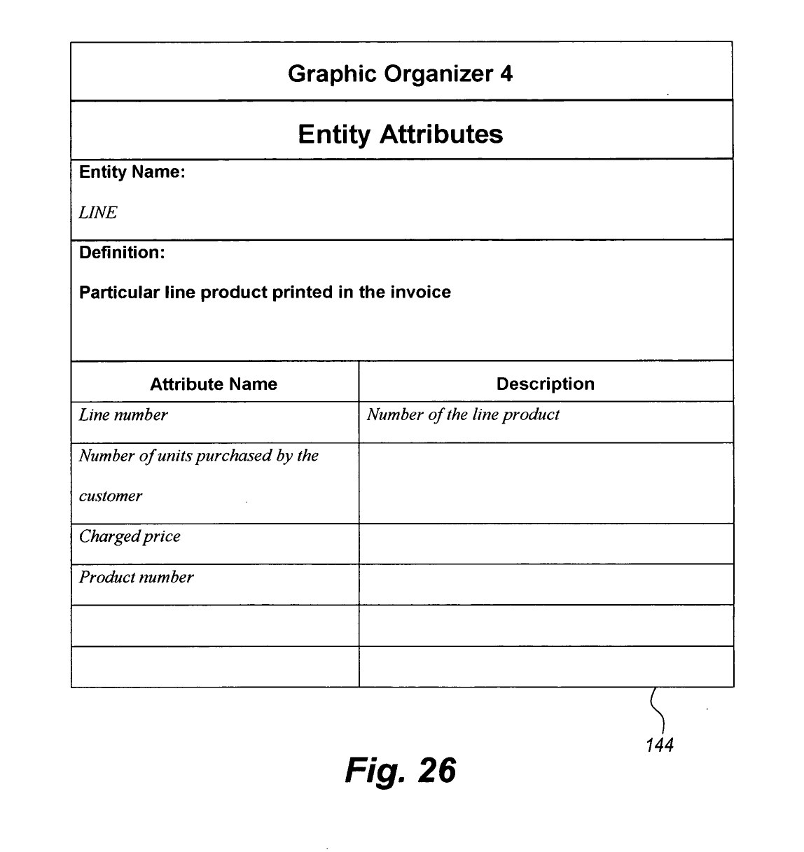

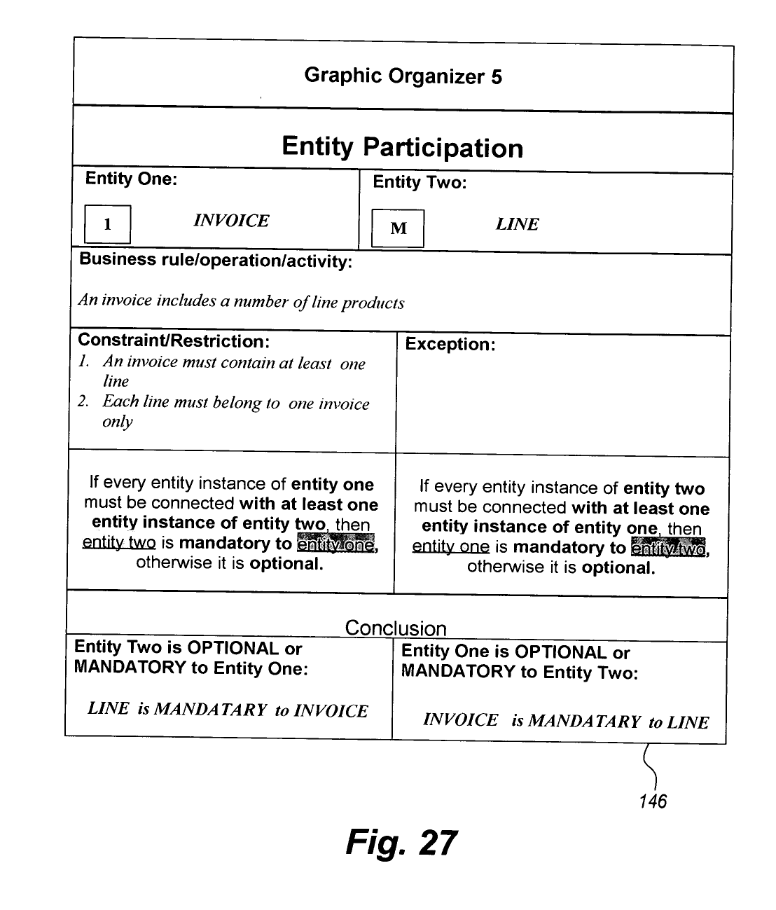

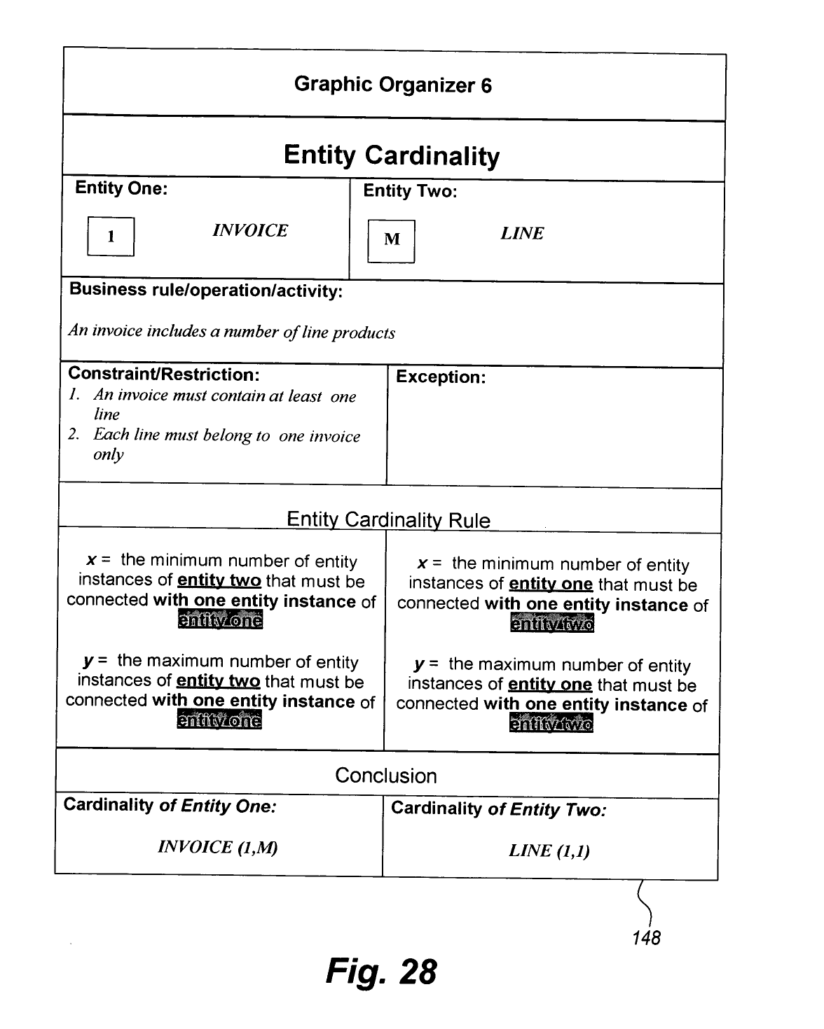

FIG. 26 shows a Graphical Organizer #4 template, designated as template 144, completed to show the attributes for the Line entity identified by template 138. FIG. 27 shows a Graphical Organizer #5 template, designated as template 146, completed for the Invoice-Line relationship identified as 1:M by template 138, and concludes that the Line entity is mandatory to the Invoice entity, and that the Invoice entity is also mandatory to the Line entity. FIG. 28 shows a Graphical Organizer #6 template, designated as template 148, showing the cardinality of the Invoice and Line entities in the Invoice-Line relationship, viz., (1,M) for the Invoice entity and (1,1) for the Line entity.

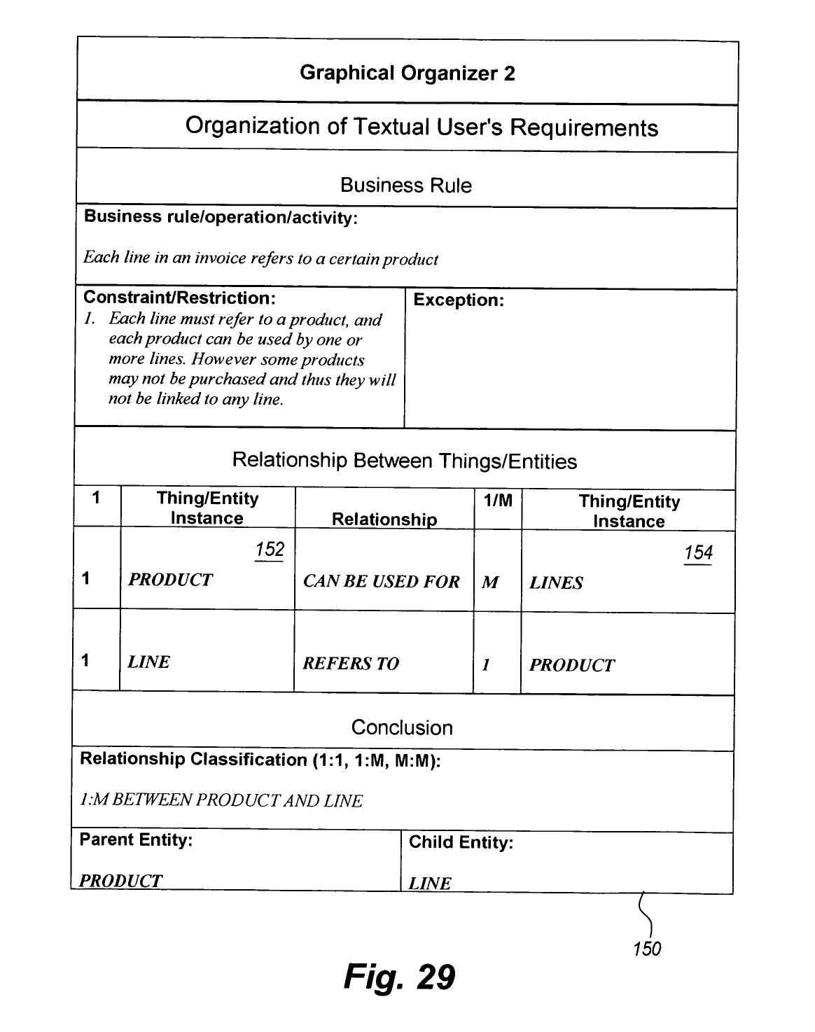

FIG. 29 shows a Graphical Organizer #2 template, designated as template 150, completed for the fourth business rule 108 identified by template 100. Template 150 names the entities identified by the fourth business rule 108 as the Product entity in block 152 and the Line Entity in block 154. The relationship is characterized as a 1:M relationship between the Product and Line Entities.

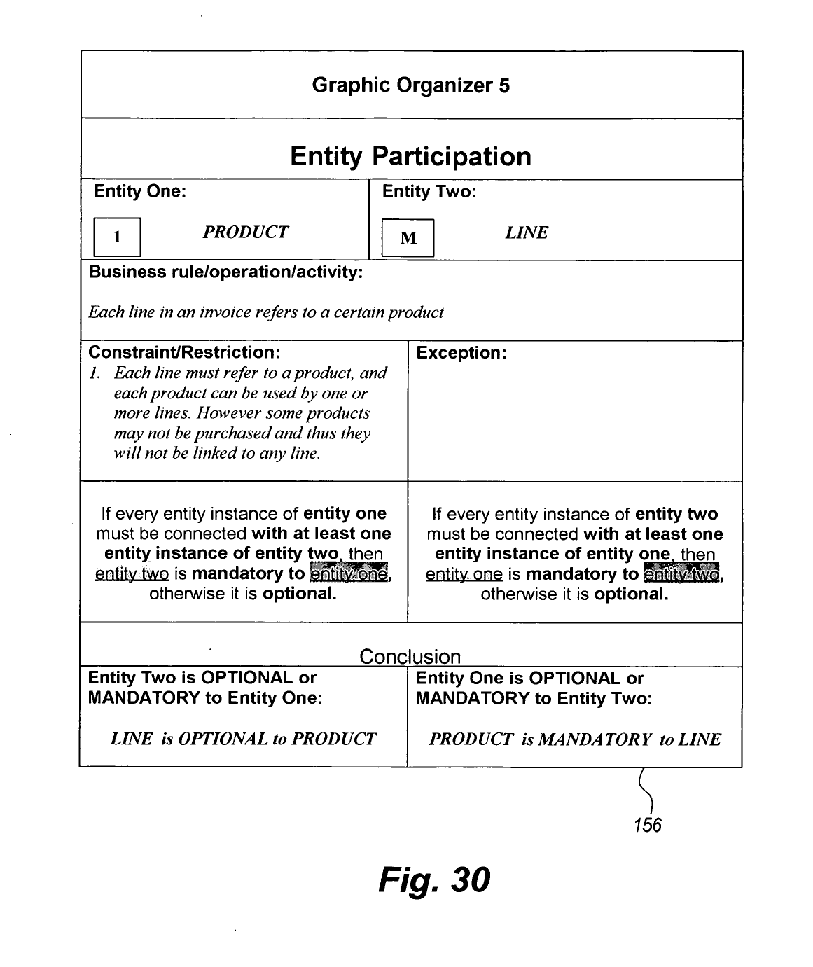

FIG. 30 shows a Graphical Organizer #5 template, designated as template 156, completed for the Invoice-Line relationship identified as 1:M by template 150, and concludes that the Line entity is optional to the Product entity, and that the Product entity is mandatory to the Line entity.

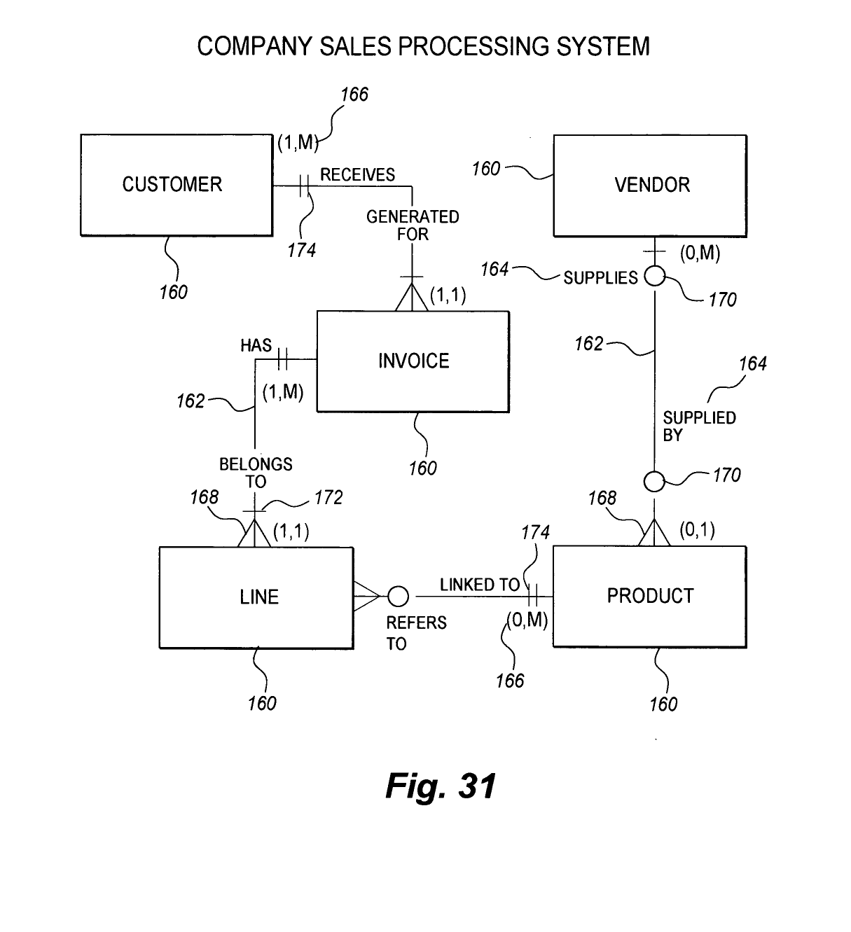

FIG. 31 shows an Entity-Relationship Diagram (ERD) prepared from the information that is graphically organized in FIGS. 14-30. The following symbolic notation conventions are observed in the ERD of FIG. 31. Entities are shown in rectangular boxes 160. Relationships are shown by solid lines 162 connecting the boxes, which are annotated by text labels 164 adjoining or breaking the connecting lines adjacent the corresponding entity. The connecting lines 162 are annotated by cardinality notation 166 adjacent the corresponding entity boxes 160.

Many entities on a given side of a relationship are notated by a crow's-foot 168. A circle 170 in the connecting line 162 denotes the possibility that entities may be related, but not in all instances. A single bar 172 in a connecting line indicates there is one entity on that side of the relationship. A double bar 174 indicates that there is one and only one entity on that side of the relationship. The completed entity-relationship diagram makes the design of the corresponding database a considerably easier task.

It will be seen by those skilled in the art that the six templates in the system of the present invention organize the data in a graphical manner that readily corresponds to the symbolic notation of ERD modeling. It will also be seen by those skilled in the art that the templates, executed in the proper sequence, provide a systematic approach to organizing the data required for completing an ERD model, rather than general guidelines that result in a hit-and-miss approach.

The present inventor has tested the method of teaching entity-relationship modeling upon groups of computer science students, including a control group (fifty-two students) and a group (sixty-four students) trained in the use of the templates, and evaluated the results on a scale of 0-100 using T-test and Levene's test and found that students trained in the use of the templates scored significantly higher (mean of 75.9844 vs. mean of 65.3846), confirming the validity of the system and method of the present invention.

It will be obvious to those skilled in the art that the templates may be computerized into forms written in hypertext markup language (HTML), extensible markup language (XML), Java®, JavaScript® (Java and JavaScript are trademarks of Sun Microsystems, Inc.), C, C++, Visual Basic® (Visual Basic is a trademark of Microsoft Corporation), or numerous other programming languages. Such forms may be used to gather data in a logical, systematic, and organized manner (testing the forms for consistency and completeness, prompting for the entry of further data or forms when necessary) as input data for a Computer Aided Software Engineering (CASE) program or other drawing program that may be used to draw or to automatically generate an Entity-Relationship Diagram from the data entries in the templates.

When the templates are computerized, the templates or computerized forms, together with any associated scripting program or application program for verifying the completeness and consistency of the templates and for integrating the data supplied by the templates into a CASE or other drawing program will be stored on a computer readable medium with instructions that, when executed by a computer processor, will display the forms on a monitor, accept and store data for completing the templates from an input device (such as a keyboard), parse the data, and translate the data into a form usable by the CASE or other drawing program.

The term “computer readable medium” refers to a hard disk drive, a floppy diskette, a ZIP disk, any other magnetic storage media capable of storing coded program instructions, an optical or laser storage device, such as a compact disk or laser disk, paper tape, punch cards, or any other media for the storage of program instructions readable by a disk storage device or reader.

It is to be understood that the present invention is not limited to the embodiments described above, but encompasses any and all embodiments within the scope of the following claims.

I claim:

1. A method for teaching entity-relationship modeling, comprising the steps of:
instructing a student to complete a first template summarizing business rules of an organization in need of a database, the first template being graphically divided into numbered sections corresponding to each of the business rules;
for each of the business rules summarized in the first template:
instructing the student to complete a second template for each pair of related data entities referenced in the business rule, the second template being graphically divided into separate blocks for containing a name for each of the entities, a relationship existing between the data entities, and a class describing a distributive relationship between the entities;
instructing the student to complete a third template for each pair of data entities having a many-to-many distributive relationship reflected on the second template, the third template being graphically divided to include a central block naming a bridge entity and lateral blocks naming the pair of data entities on opposite sides of the block naming the bridge entity, each of the data entities having a one-to-many distributive relationship with the bridge entity;
drawing an entity-relationship diagram segment from the completed second and third templates, the drawing being performed by the student;
instructing the student to complete a fourth template for each entity named in the second template, the fourth template being graphically divided to contain a block for a name for each attribute of the data entity and a corresponding block for a description of the named attribute, and adding the attributes to the segment;
instructing the student to complete a fifth template graphically divided to define optional and mandatory participation of each of the pair of data entities in the relationship named in the second template, and symbolically notating the segment accordingly;
instructing the student to complete a sixth template graphically divided to define cardinality of each of the data entities, and symbolically annotating the segment accordingly; and
integrating the entity-relationship diagram segments for all of the business rules to form an integrated entity-relationship diagram for the organization, the integrating being performed by the student.

2. The method for teaching entity-relationship modeling according to claim 1, further comprising the step of instructing the student to design a database from the integrated entity-relationship diagram.

3. The method for teaching entity-relationship modeling according to claim 1, wherein each of the numbered sections of said first template contains separate blocks for listing the business rule, identifying constraints and restrictions on the business rule, and identifying exceptions to the business rule.

4. The method for teaching entity-relationship modeling according to claim 1, wherein the class of distributive relationship is selected from the group consisting of a one-to-one relationship, a one-to-many relationship, and a many-to-many relationship.

5. The method for teaching entity-relationship modeling according to claim 1, wherein said templates comprise computerized forms stored on a computer readable medium together with instructions which, when executed by a computer processor, test the forms for completeness and consistency.

6. The method for teaching entity-relationship modeling according to claim 5, wherein said steps of drawing the entity-relationship diagram segments, adding to the segments, and integrating the segments are performed on a computer using a computer drawing program, said forms providing input data to the drawing program.

7. A method of preparing an entity-relationship diagram, comprising the steps of:
completing a first template summarizing business rules of an organization in need of a database, the first template being graphically divided into numbered sections corresponding to each of the business rules;
for each of the business rules summarized in the first template:
completing a second template for each pair of related data entities referenced in the business rule, the second template being graphically divided into separate blocks for containing a name for each of the entities, a relationship existing between the data entities, and a class describing a distributive relationship between the entities;
completing a third template for each pair of data entities having a many-to-many distributive relationship reflected on the second template, the third template being graphically divided to include a central block naming a bridge entity and lateral blocks naming the pair of data entities on opposite sides of the block naming the bridge entity, each of the data entities having a one-to-many distributive relationship with the bridge entity;
drawing an entity-relationship diagram segment from the completed second and third templates;
completing a fourth template for each entity named in the second template, the fourth template being graphically divided to contain a block for a name for each attribute of the data entity and a corresponding block for a description of the named attribute, and adding the attributes to the segment;
completing a fifth template graphically divided to define optional and mandatory participation of each of the pair of data entities in the relationship named in the second template, and symbolically notating the segment accordingly;
completing a sixth template graphically divided to define cardinality of each of the data entities, and symbolically annotating the segment accordingly; and
integrating the entity-relationship diagram segments for all of the business rules to form an integrated entity-relationship diagram for the organization.

8. The method of preparing an entity-relationship diagram according to claim 7, further comprising the step of designing a database from the integrated entity-relationship diagram.

9. The method of preparing an entity-relationship diagram according to claim 7, wherein each of the numbered sections of said first template contains separate blocks for listing the business rule, identifying constraints and restrictions on the business rule, and identifying exceptions to the business rule.

10. The method of preparing an entity-relationship diagram according to claim 7, wherein the class of distributive relationship is selected from the group consisting of a one-to-one relationship, a one-to-many relationship, and a many-to-many relationship.

11. The method of preparing an entity-relationship diagram according to claim 7, wherein said templates comprise computerized forms stored on a computer readable medium together with instructions which, when executed by a computer processor, test the forms for completeness and consistency.

12. The method of preparing an entity-relationship diagram according to claim 11, wherein said steps of drawing the entity-relationship diagram segments, adding to the segments, and integrating the segments are performed on a computer using a computer drawing program, said forms providing input data to the drawing program.

13. A system for teaching entity-relationship modeling, comprising:
a first template summarizing business rules of an organization in need of a database, the first template being graphically divided into numbered sections corresponding to each of the business rules;
a second template for each pair of related data entities referenced in the business rules, the second template being graphically divided into separate blocks for containing a name for each of the entities, a relationship existing between the data entities, and a class describing a distributive relationship between the entities;
a third template for each pair of data entities having a many-to-many distributive relationship reflected on the second template, the third template being graphically divided to include a central block naming a bridge entity and lateral blocks naming the pair of data entities on opposite sides of the block naming the bridge entity, each of the data entities having a one-to-many distributive relationship with the bridge entity;
a fourth template for each entity named in the second template, the fourth template being graphically divided to contain a block for a name for each attribute of the data entity and a corresponding block for a description of the named attribute;
a fifth template graphically divided to define optional and mandatory participation of each of the pair of data entities in the relationship named in the second template; and
a sixth template graphically divided to define cardinality of each of the data entities.

14. The system for teaching entity-relationship modeling according to claim 13, wherein each of the numbered sections of said first template contains separate blocks for listing the business rule, identifying constraints and restrictions on the business rule, and identifying exceptions to the business rule.

15. The system for teaching entity-relationship modeling according to claim 13, wherein the class of distributive relationship is selected from the group consisting of a one-to-one relationship, a one-to-many relationship, and a many-to-many relationship.

16. The system for teaching entity-relationship modeling according to claim 13, further comprising a computer readable medium, said templates comprising computerized forms stored on the computer readable medium together with instructions which, when executed by a computer processor, test the forms for completeness and consistency.

17. The system for teaching entity-relationship modeling according to claim 16, further comprising a computer drawing program stored on said computer readable medium, said forms providing input data to the drawing program.
